(19) United States
(12) Patent Application Publication
(10) Pub. No.: US 2024/0322898 A1
(43) Pub. Date: Sep. 26, 2024

(54) AUTHORIZATION FOR AN UNMANNED AERIAL VEHICLE

(71) Applicant: Lenovo (Singapore) Pte. Ltd., New Tech Park (SG)

(72) Inventors: Dimitrios Karampatsis, Ruislip (GB); Genadi Velev, Darmstadt (DE)

(21) Appl. No.: 18/261,195

(22) PCT Filed: Jan. 13, 2022
(86) PCT No.: PCT/IB2022/050275

§ 371 Date: Jul. 12, 2023

Related U.S. Application Data
(60) Provisional application No. 63/137,039, filed on Jan. 13, 2021.

(51) Int. Cl. H04B 7/185; H04W 12/08

(52) U.S. Cl. CPC H04B 7/18504; H04W 12/08

(57) ABSTRACT

Apparatuses, systems, and methods for receiving authorization for an unmanned aerial vehicle (or uncrewed aerial vehicle) (UAV) are disclosed. One method (700) includes receiving (705) a first request from an Access and Mobility Management Function (143) in which the first request includes an indication to establish user plane resources for Unmanned Aerial System (“UAS”) services for a UAV device (106). The method further includes retrieving (710) subscription information from a Unified Data Management (149) node, the subscription information indicating that UAV authorization is required by a UAS Service Subscriber (157) and/or CAS Traffic Management (157) server, and sending (715) a second request to a UAS network function (147) to initiate the UAV authorization.

### CROSS-REFERENCE TO RELATED APPLICATIONS

This application claims priority to U.S. Provisional Patent Application No. 63/137,039 entitled, METHOD TO EXCHANGE UAV CREDENTIALS BETWEEN A UAV AND 3GPP NETWORK FOR UAV AUTHORIZATION,” filed on Jan. 13, 2021 for Dimitrios Karampatsis et al., which is incorporated herein by reference.

### FIELD

The subject matter disclosed herein relates generally to wireless communications and more particularly relates to receiving authorization for an unmanned aerial vehicle or uncrewed aerial vehicle (“UAV”) (e.g., from a 3GPP network).

### BACKGROUND

Unmanned Aerial System Service Supplier (“USS”) Unmanned Aerial Vehicle (“UAV”) Authorization/Authentication (“UUAA”) may be carried out by, for example, a 3GPP network when a UAV registers with the 3GPP network or when the UAV transmits a request to establish a data connection (e.g., a Packet Data Unit (“PDU”) Session) with the 3GPP network. For the UAV to request resources for UAV operation from the 3GPP network requires the UAV to have a prior flight authorization from an Unmanned Aerial System Traffic Management (“UTM”) system. This approach is cumbersome given that an Unmanned Aerial System (“UAS”) operator would need to request flight authorization for the UAV from the UTM before the UAS operator issues a request for a PDU session with the 3GPP network for UAV operation.

### BRIEF SUMMARY

Disclosed are apparatus, systems, and methods for receiving UAV authorization for an unmanned aerial vehicle or uncrewed aerial vehicle (“UAV”). One method includes receiving a first request from an Access and Mobility Management Function (“AMF”), the first request including an indication to establish user plane resources for Unmanned Aerial System (“UAS”) services for a UAV device, retrieving subscription information from a Unified Data Management node (“UDM”), the subscription information indicating that UAV authorization is required by a UAS Service Subscriber (“USS”) and/or UAS Traffic Management (“UTM”) server, and sending a second request to a UAS network function (“UAS-NF”) to initiate the UAV authorization.

Another method for receiving UAV authorization for a UAV includes receiving a first request to authenticate a UAV device for UAS services, determining whether the UAV device has a valid UAV authorization by checking a database storing information of UA Vs that have been successfully authorized, determining an external identifier of the UAV device based on a second identifier, and sending a second request to authenticate the UAV device with a UTM system in which the second request comprises the external identifier and the second identifier. This method further includes receiving a UAV authorization result for the UAV device from the UTM system and storing in the database an UAV context that indicates that the UAV device is authorized for UAS services in which said UAV context comprises one or more of the external identifier and the second identifier.

Still another method for receiving UAV authorization for a UAV includes receiving a registration request to establish one or more user plane resources for UAS services for a UAV device and determining whether the UAV device has a valid prior UAV authorization by checking a locally stored User Equipment (“UE”) context. The method further includes initiating a UAV authorization procedure in response to determining that no valid UAV authorization is stored for the UAV device, transmitting a first request to a Session Management Function (“SMF”), the first request including an indication to establish one or more user plane resources for UAS services for a UAV device, receiving UAV authorization for the UAV device from the SMF in which the UAV authorization is approved by a UTM system, and transmitting the UAV authorization to the UAV device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for receiving UAV authorization for an unmanned aerial vehicle or uncrewed aerial vehicle:

FIG. 2A is a signal flow diagram illustrating one embodiment of a procedure to support UUAA and/or C2 authorization at PDU session establishment:

FIG. 2B is a continuation of the procedure of FIG. 2A:

FIG. 2C is a continuation of the procedure of FIGS. 2A and 2B;

FIG. 2D is a continuation of the procedure of FIGS. 2A and 2B and 2C;

FIG. 3A is a signal flow diagram illustrating one embodiment of a procedure to support UUAA at Registration:

FIG. 3B is a continuation of the procedure of FIG. 3A:

FIG. 3C is a continuation of the procedure of FIGS. 3A and 3B;

FIG. 3D is a continuation of the procedure of FIGS. 3A and 3B and 3C:

FIG. 4 is a block diagram illustrating one embodiment of a UAS architecture in a 3GPP system:

FIG. 5 depicts is a block diagram illustrating one embodiment of a user equipment apparatus that may be used for receiving UAV authorization for a UAV:

FIG. 6 is a block diagram illustrating one embodiment of a network equipment apparatus that may be used for receiving UAV authorization for a UAV:

FIG. 7 is a flowchart diagram illustrating one embodiment of a method for receiving UAV authorization for a UAV:

FIG. 8 is a flowchart diagram illustrating another embodiment of a method for receiving UAV authorization for a UAV; and

FIG. 9 is a flowchart diagram illustrating still another embodiment of a method for receiving UAV authorization for a UAV.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for receiving UUAA and/or C2 authorization for an unmanned aerial vehicle or uncrewed aerial vehicle (“UAV”).

Disclosed are solution for exchanging UAV credentials between a UAV and 3GPP network for UAV authorization. The below described solutions disclose how the 3GPP network obtains from the UAV the required parameters to carry out UUAA and C2 authorization, how UUAA authorization can be enforced on per slice level, how a UAV requests user plane resources for UAV operation without having a prior flight authorization, and how the UAV knows whether the UUAA is performed during the registration procedure or during the PDU Session establishment procedure.

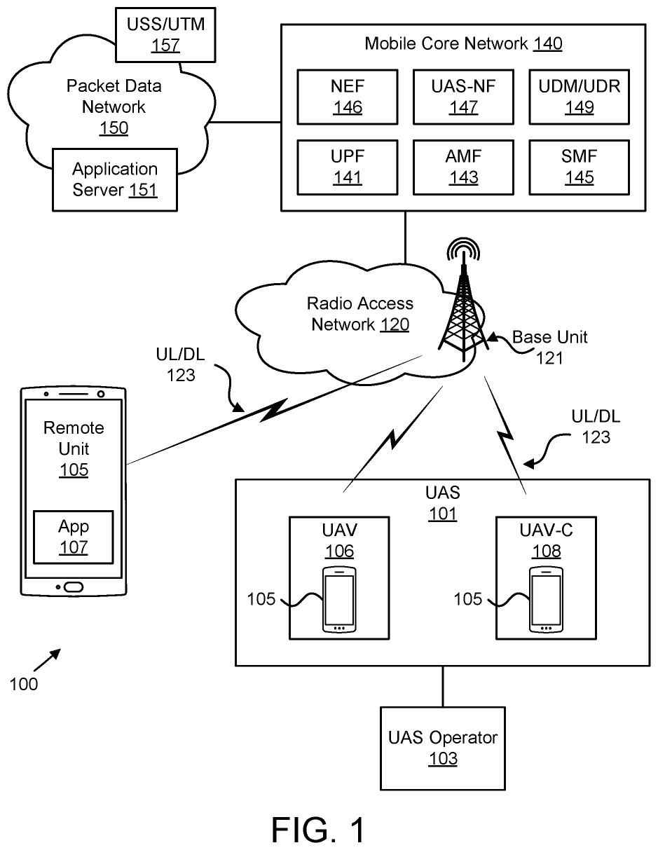

FIG. 1 depicts a wireless communication system 100 supporting exchanging UAV credentials between a UAV and 3GPP network for UAV authorization, according to embodiments of the disclosure. In one embodiment, the wireless communication system 100 includes at least one remote unit 105, a UAV 106, and a UAV Controller (“UAV-C”) 108, which may include an instance of a remote unit 105, a radio access network (“RAN”) 120 (e.g., a NG-RAN), and a mobile core network 140. The RAN 120 and the mobile core network 140 form a mobile communication network. The RAN 120, in various embodiments, comprises a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any quantity of remote units 105, base units 121, wireless communication links 123, RANs 120, and mobile core networks 140 may be included in the wireless communication system 100.

An Unmanned Aerial System or Uncrewed Aerial System (“UAS”) 101, in various embodiments, includes an Unmanned Aerial Vehicle or Uncrewed Aerial Vehicle (“UAV”) 106, e.g., a “drone,” and an UAV Controller (“UAV-C”) 108. The UAS Operator 103 is, for example, the person who operates the UAV 106 (e.g., via the UAV Controller 108) and who, typically, issues requests for flight authorizations. The UAV 106 and UAV controller 108 may each be Aerial UEs in the wireless communication system 100 and/or may include an instance of a remote unit 105. As such, the UAV 106 may communicate with a RAN 120 to access services provided by a mobile core network 140.

In some embodiments, the Aerial UEs (i.e., remote units 105) communicate with one or more UAV Traffic Management (“UTM”) functions via a network connection with the mobile core network 140. As described below, the UAV 106 and/or UAV Controller 108 may establish a PDU session (or similar data connection) with the mobile core network 140 using the RAN 120. The mobile core network 140 is configured to relay traffic between the Aerial UE and the packet data network 150 using the PDU session.

In certain embodiments, the RAN 120 is compliant with the 5G system specified in the 3GPP specifications. In other embodiments, the RAN 120 is compliant with the LTE system specified in the 3GPP specifications. More generally, however, the wireless communication system 100 may implement some other open or proprietary communication network, for example WiMAX, among other networks that are possible and contemplated herein. Notably, the present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as “UEs,” subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more downlink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., a UAS application) in a remote unit 105 may trigger the remote unit 105 to establish a PDU session (or other data connection) with the mobile core network 140 via the RAN 120. The mobile core network 140 then relays traffic between the remote unit 105 and the application server 151 (e.g., a UAS Application-specific server) in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may concurrently have at least one PDU session for communicating with the packet data network 150 and at least one PDU session for communicating with other data networks and/or other communication peers (not shown).

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed and/or positioned over a geographic region. In certain embodiments, a base unit 121 may also be referred to as an access terminal, an access point, a base, a base station, a Node-B (“NB”), an Evolved Node B (abbreviated as “eNodeB” or “eNB”), a 5G/NR Node B (“gNB”), a Home Node-B, a relay node, a RAN node, or by any other terminology used in the art. The base units 121 are generally part of a radio access network (“RAN”), such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may include any suitable carrier in the licensed or unlicensed radio spectrum. The wireless communication links 123 are configured to facilitate communication between one or more of the remote units 105 and/or one or more of the base units 121. Note that during NR operation on unlicensed spectrum (referred to as “NR-U” operation), the base unit 121 and the remote unit 105 communicate over the unlicensed (i.e., shared) radio spectrum.

In one embodiment, the mobile core network 140 is a 5G core (“5GC”) or the evolved packet core (“EPC”), which may be coupled to a packet data network 150, like the Internet and private data networks, among other data networks. A remote unit 105 may have a subscription or other account with the mobile core network 140. Each mobile core network 140 belongs to a single mobile network operator (“MNO”) and/or public land mobile network (“PLMN”). The present disclosure is not intended to be limited to the implementation of any particular wireless communication system architecture or protocol.

The mobile core network 140, in some embodiments, includes several network functions (“NFs”). As depicted, the mobile core network 140 includes at least one user plane function (“UPF”) 141. The mobile core network 140 also includes multiple control plane (“CP”) functions including, but not limited to, an Access and Mobility Management Function (“AMF”) 143 that serves the RAN 120, a Session Management Function (“SMF”) 145, a UAS Network Function (“UAS-NF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

To support UAS operation and related security aspects, the mobile core network 140 may also include a UAS-NF 147 for interacting with a UAS Service Supplier (“USS”) system and/or a UAS Traffic Management (“UTM”) system (depicted as combined node “USS/UTM” 157). The USS/UTM 157, in one embodiment, provides a set of overlapping USSs that assist UAS operators 103 in conducting safe and compliant operations. The services may include deconfliction of flight plans, remote identification, and/or the like. In another embodiment, the USS/UTM 157 may be used to associate (i.e., pair) a UAV 106 with a UAV-C 108. Here, each UAV 106 provides its identity to the USS/UTM 157 and the USS/UTM 157 authorizes the request. The USS/UTM 157 may be located outside the mobile core network and may interact with core network function, such as the UAS-NF 147, via the Network Exposure Function (“NEF”) 146.

While depicted as a standalone network function, in an alternative deployment of the system 100, the UAS-NF 147 may be implemented as a service offered by NEF 146. The UAS-NF 147 is supported by the NEF 146 (or by both an NEF and Service Capability Exposure Function (“SCEF”)-denoted “NEF/SCEF”) and is used for external exposure of services to the USS. In some embodiments, the UAS-NF 147 uses existing NEF/SCEF exposure services for UAV authentication/authorization, for UAV flight authorization, for UAV/UAV-C pairing authorization, and related revocation: for location reporting, and control of QoS/traffic filtering for Command and Control (“C2”) communication.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network instance may be identified by a single-network slice selection assistance information (“S-NSSAI”), while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for case of illustration, but their support is assumed.

While FIG. 1 depicts components of a 5G RAN and a 5G core network, the described embodiments apply to other types of communication networks and RATs, including IEEE 802.11 variants, GSM, GPRS, UMTS, LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PDN Gateway (“PGW”), a Home Subscriber Server (“HSS”), Authentication Center (“AuC”), and the like. For example, the AMF 143 may be mapped to an MME, the SMF 145 may be mapped to a control plane portion of a PGW (“PGW-C”) and/or to an MME, the UPF 141 may be mapped to an SGW and a user plane portion of the PGW (“PGW-U”), the UDM/UDR 149 may be mapped to an HSS/AuC, etc.

In the following descriptions, the term “gNB” is used for the base station but it is replaceable by any other radio access node, e.g., RAN node, eNB, Base Station (“BS”), ng-eNB, gNB, Access Point (“AP”), etc. Additionally, the term “UE” is used for the mobile station/remote unit, but it is replaceable by any other remote device, e.g., remote unit, MS, ME, etc. Further the operations are described mainly in the context of 5G NR. However, the proposed solutions/methods are also equally applicable to other mobile communication systems supporting UAS.

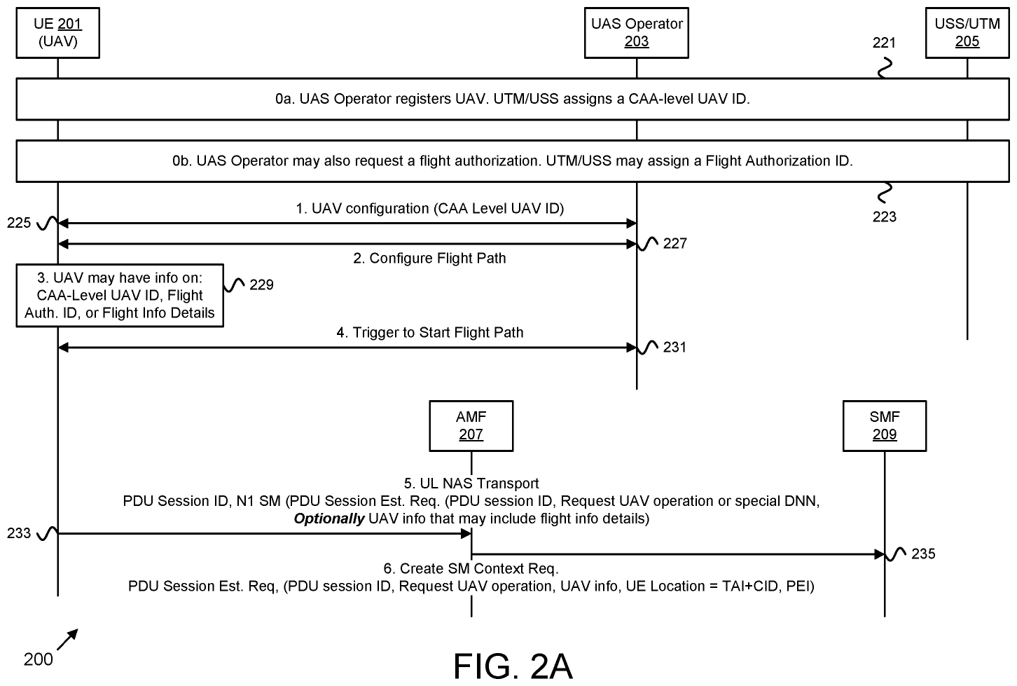

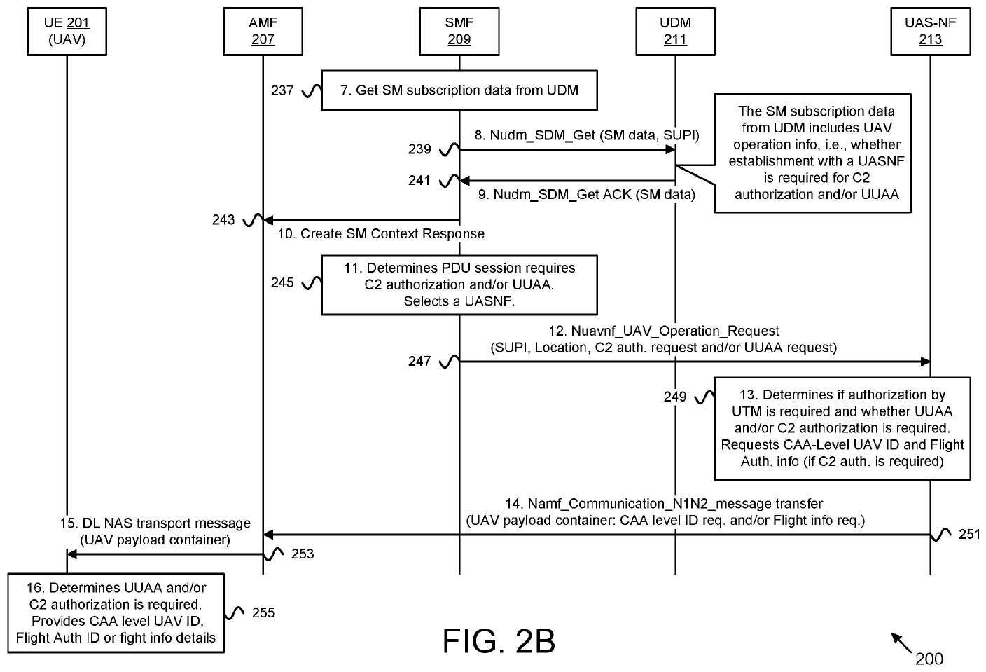

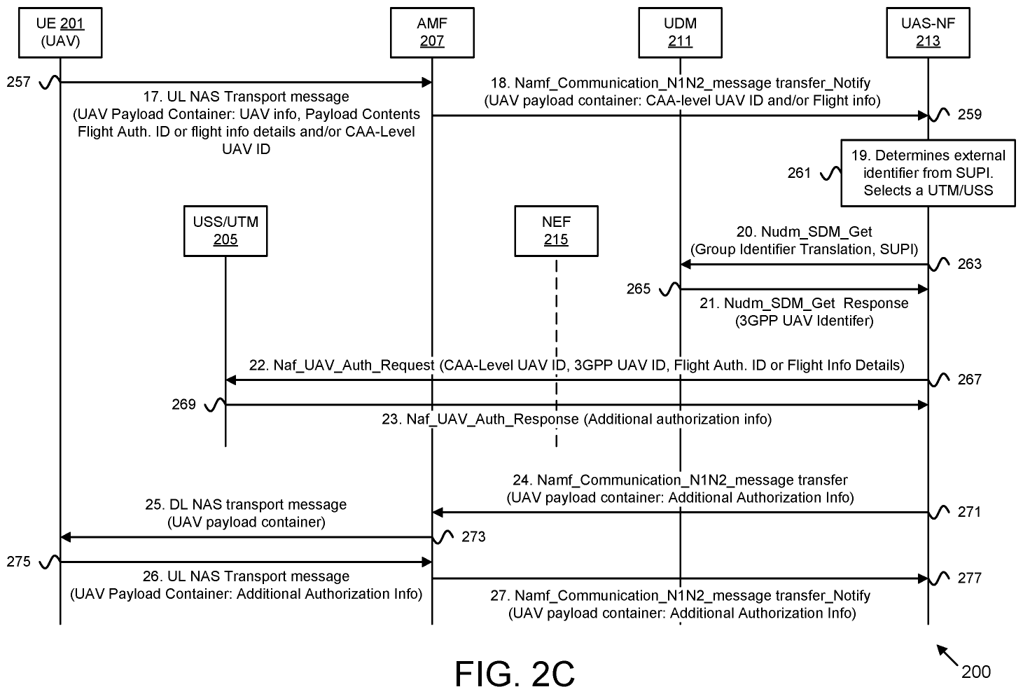

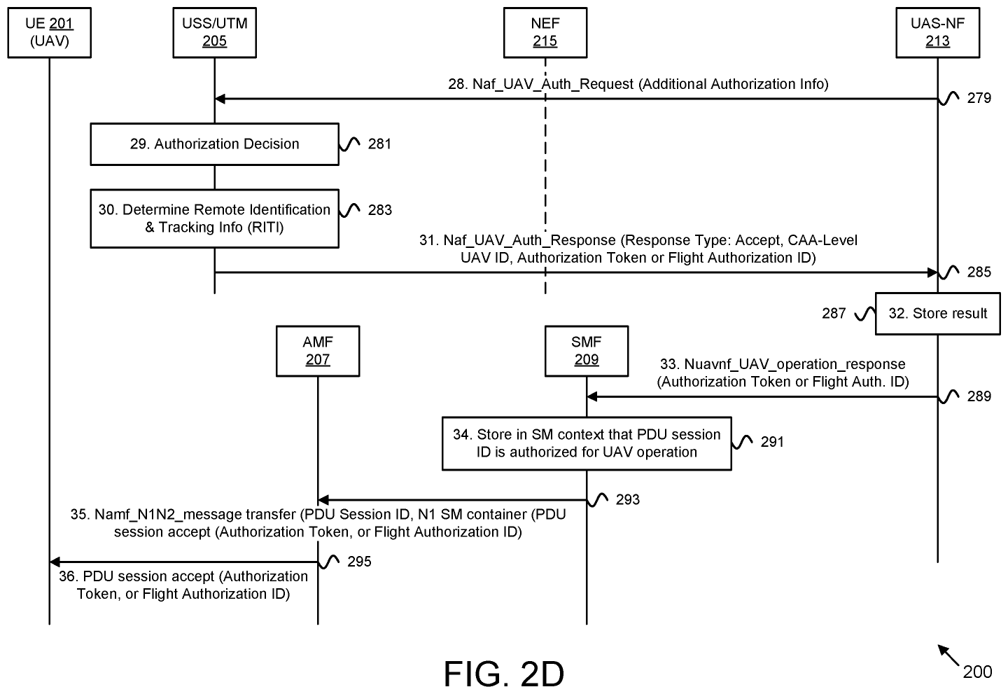

According to a first solution (see, e.g., FIGS. 2A through 2D), UUAA and C2 authorization are supported at PDU session establishment. The first solution captures at least the following use cases:

Case 1: A UAV 106 requests Flight Authorization from a UTM/USS when the UE 105 requests a PDU session. The UAV 106 includes Flight Info Details (i.e., Flight path, time of day, pilot name) within the UAV container in the PDU session establishment request. The Flight Info Details are used by the UTM/USS to authorize a flight for a UAV 106. The UTM/USS carries out a combined C2 authorization for the PDU session and Flight Authorization for the UAV flight.

Case 2: The UAV 106 does not include UAV information at a PDU session establishment request because the UAV 106 does not know if UUAA is supported by a Registration or PDU session establishment request.

When a UAV 106 requires data connectivity (e.g., IP connectivity), the UAV 106 initiates a PDU session establishment, e.g., according to standard procedures as defined in 3GPP TS 23.502. In one embodiment, the UAV may include a CAA-Level UAV ID, Flight Authorization ID or Flight Info Details, i.e., if Case 1 applies. Alternatively, the UAV does not include any UAV information in the PDU session establishment request, i.e., if Case 2 applies.

The SMF (e.g., SMF 145) determines if the PDU sessions needs to be authorized by a UAS-NF (e.g., the UAS-NF 155) based on subscription information provided by a UDM/UDR (e.g., the UDM/UDR 149). The SMF obtains the Session Management Subscription Data from the UDM/UDR using the Subscriber Permanent Identifier (“SUPI”) of the UAV 106 as a Data Key.

The Session Management (“SM”) Subscription Data include, for each DNN in S-NSSAI level subscription data, whether UUAA and/or C2 authorization is required. A new field can be included within the Session Management Subscription Data, e.g., a “UAV operations” field or “Aerial service” field, that includes information regarding whether UUAA or C2 authorization is required for the requested PDU session. In an alternative embodiment, separate fields for UUAA authorization requirement and/or C2 authorization requirements are specified. Table 1 shows an example with both options.

TABLE 1
Example of SM Subscription data for UAV operations

| Subscription | | |
|---|---|---|
| data type | Field | Description |
| Session | Session Management Subscription data contains one | |
| Management | or more S-NSSAI level subscription data: | |
| Subscription data | S-NSSAI | Indicates the value of the S-NSSAI. |
| (data needed for | Subscribed DNN list | List of the subscribed DNNs for |
| PDU session | | the S-NSSAI. |
| establishment) | For each DNN in S-NSSAI level subscription data: | |
| | UAV operations | Indicates whether UUAA and/or C2 |
| | (Option 1) | authorization is required |
| | UUAA required | Indicates that UUAA authorization |
| | (Option 2) | is required for this PDU session |
| | C2 authorization required | Indicates that the PDU session |
| | (Option 2) | needs to be authorized for C2 |

The SMF determines whether UUAA and/or C2 authorization is required. In one embodiment, the SMF may check if the UAV has a valid prior authorization. That is, the SMF checks its internal database or its SM context to determine if there is a valid UUAA or C2 authorization for the UAV. If no valid authorization exists, the SMF 145 selects an UAS-NF 147 to authorize the UAV. That is, the SMF 145 can send an “Nuavnf_UAV_Operation” request service operation to the selected UAS-NF 147 for UUAA and/or C2 authorization.

In one embodiment, the Nuavnf_UAV_operation request may indicate in the request whether UUAA and/or C2 authorization is required. The request includes the information provided by the UAV 106 within a UAV container (e.g., if provided by the UAV 106). In an alternative embodiment, separate service operation requests are sent to the UAS-NF 147 (i.e., Nuavnf_C2_operation request and Nuavnf_UUAA_request).

The UAS-NF 147 may check if the UAV 106 has a valid prior authorization by checking the provided (e.g., if provided by the UAV) CAA-Level UAV ID and/or Flight Authorization ID. The UAS-NF 147 determines if UUAA and/or C2 authorization is required for the UAV 106 by checking if there is an existing valid UUAA or C2 authorization for this UAV 106 in its internal database. If the UAV 106 did not include a UAV container in the PDU session establishment request or the UAS-NF 147 determines that the information provided by the UAV 106 has expired, the UAS-NF 147 requests the UAV 106 to provide the required information to support UUAA or C2 authorization (i.e., to provide CAA-Level UAV ID and/or Flight Authorization ID).

Accordingly, the first solution can define a new protocol between the UAV 106 and the UAS-NF 147 to exchange UAV-related information. The communication is carried out between the UAS-NF 147 and the UAV 106 via an AMF (e.g., the AMF 143). The UAS-NF 147 sends a request to the UAV 106 by invoking an Namf_Communication_N1N2_Message Transfer to the AMF 143. The message includes a Subscriber Permanent Identifier (“SUPI”) to identify the UE/UAV 106 and a UAV Payload Container.

The UAV payload container contains the protocol used between the UAV 106 and UAS-NF 147 to exchange UAV information. Example protocol messages include, for example: a CAA-Level UAV ID request and/or a Flight Information Request.

The AMF 143 extracts the UAV information and sends the UAV Payload container to the UE (i.e., remote unit 105) within a DL NAS Transport message. The DL NAS transport message includes a new type of the payload identified by the Payload container type IE (i.e., a UAV Payload).

The UAV 106 determines from the Payload Container type that the message is for the UAV application (i.e., application 107) in the UAV 106. Based on the UAV protocol message request, the UAV 106 provides the requested information. The UAV 106 includes the requested information within a UL NAS Transport message that includes a UAV Payload container and the payload container type IE set to UAV Payload that is received by an AMF 143. The AMF 143, based on the payload type, determines whether the message is to be sent to a UAS-NF 147. The AMF 143 includes the UAV Payload within an Namf_Communication_N1N2_Message Transfer Notify service operation.

When the UAS-NF 147 obtains the UAV information, the UAS-NF 147 selects a UTM/USS 157 and initiates the authorization procedure by invoking the Naf_UAV_Auth_request service operation. The message includes the CAA-Level UAV ID, 3GPP UAV ID Flight Authorization ID and/or Flight Information details. The message may be transported via an NEF 146. The UTM/USS 157 authorizes the request and may assign an authorization token. The UTM/USS 157 may also authorize the flight if the Flight Information Details were included. In such a case, the UTM/USS 157 may assign a Flight Authorization ID. The UTM/USS 157 provides the authorization result to the UAS-NF 147 within an Naf_UAV_Auth_response message.

The UAS-NF 147 stores the authorization result in its internal database and provides the authorization result to the SMF 145 within an Nuavnf_UAV_operation response message. The message includes details whether UUAA and/or C2 authorization were successful. The message also includes the authorization token or flight authorization ID. The SMF 145 stores in the SM context that the PDU session ID is authorized for UUAA and/or C2 and provides a PDU session accept to the UAV 106. The PDU session accept message may include in a UAV payload the authorization token or flight authorization ID.

Note that the UUAA procedure can be performed either during the registration procedure or during PDU Session establishment procedure. The use of the one or other alternatives may depend on the support in the UE/UAV 106 or in the network. Having two alternatives may require that the UE/UAV 106 is (pre-)configured to know which alternative is supported in the network. In one possible solution, the UE/UAV 106 may be configured via the universal integrated circuit card (“UICC”) or Universal Subscriber Identity Module (“USIM”) provided from the home network (e.g., called HPLMN). However, in the solution proposed in this document, the UE/UAV does not need to be configured (or pre-configured).

The UE/UAV 106 is not required to know which UUAA procedure the network supports. The network can request the UE/UAV 106 to provide the identity and credential(s) for UUAA (or the C2) authentication. It is up to the network configuration or preference whether the network initiates the UUAA procedure during the registration procedure or during the PDU Session establishment procedure. For example, the subscription data stored in the UDM/UDR 149 may include UUAA-related information either in the Access and Management subscription parameters or in the session management subscription parameters, which triggers the UUAA procedure correspondingly either during the registration or during the PDU Session establishment procedure. Note that while the above descriptions refer to the UAV 106 and it Aerial UE, the above solutions also apply to the UAV-C 108 and its Aerial UE.

FIGS. 2A through 2D depict an exemplary procedure 200 for UUAA and C2 authorization at PDU session establishment, according to embodiments of the first solution. The procedure 200 involves a UE 201 (e.g., the Aerial UE of a UAV and one embodiment of the remote unit 105), a UAS operator 203 (e.g., one embodiment of the UAS operator 103), an USS/UTM server 205 (e.g., one embodiment of the USS/UTM 157), an AMF 207 (e.g., one embodiment of the AMF 143), an SMF 209 (e.g., one embodiment of the SMF 145), a UDM 211 (e.g., one embodiment of the UDM/UDR 149), a UAS-NF 213 (e.g., one embodiment of the UAS-NF 147), and a NEF 215 (e.g., one embodiment of the NEF 146). The steps of the procedure 200 are as follows:

Beginning on FIG. 2A, as a precondition, at Step 0a a UAS Operator 203 registers a UAS (e.g., UAV 106 and UAV controller 108) to a USS provider, e.g., the USS/UTM server 205 (see block 221). Here, it is assumed that the UAS Operator 203 registers the UE 201 and corresponding UAV. The USS/UTM server 205 assigns a CAA-Level UAV ID for the UAV (i.e., of the UE 201).

As an optional precondition, at Step Ob, the UAS Operator 203 may request a flight authorization from its USS provider (i.e., USS/UTM server 205) (see step 223). The USS/UTM 205 may assign a Flight Authorization ID for the authorized flight.

At Step 1, the UAS Operator 203 configures the UE 201 (i.e., UAV) with the assigned CAA-Level UAV ID to the UE 201 (i.e., UAV) (see messaging 225). In one embodiment, the CAA-Level UAV ID may be assigned by the USS/UTM server 205 to the UE 201 (i.e., UAV) via IP connectivity. In another embodiment, the CAA-Level UAV ID may be assigned by the USS/UTM server 205 to the UE 201 (i.e., UAV) via NAS signaling.

At Step 2, the UAS Operator 203 may assign flight information to the UE 201 (i.e., UAV) (see messaging 227). The flight information may include the flight Authorization ID for the authorized flight (e.g., if step Ob has been carried out) or alternatively includes Flight Information Details (e.g., Flight Path information, Pilot name, time of flight, etc.) if the flight authorization is to be carried out at the establishment of a PDU session (i.e., combined flight authorization and C2 authorization).

At Step 3, based on steps 1 and 2, the UE 201 (i.e., UAV) has information on the CAA-Level UAV ID, Flight Authorization ID (which may additionally include credentials in inform of an authorization token), and/or Flight Information Details (see block 229).

At Step 4, the UE 201 (i.e., UAV) is triggered (e.g., by the UAS operator 203) to establish IP connectivity (e.g., to start a flight) (see messaging 231).

At Step 5, the UE 201 (i.e., UAV) starts a PDU Session Establishment Request (see messaging 233), where the request includes a PDU session ID and either an indication of a request for UAV operation or a special DNN that is used for UAV operations. If case 1 applies (i.e., where the UAV requests Flight Authorization its Aerial UE requests a PDU session), then the UE 201 may include Flight Information details within a UAV payload (i.e., to request flight authorization) within the PDU session establishment request according to Step 2. If Case 2 applies (i.e., where the UAV does not include UAV information in the PDU session establishment request), then the UE 201 may not provide CAA Level UAV ID and/or Flight Information details.

At Step 6, the PDU session establishment is received by an AMF 207. The AMF 207 sends a Create SM Context request to the SMF 209 including an indication of UAV operation (see messaging 235).

Continuing onto FIG. 2B, at Step 7, the SMF 209 determines to retrieve Session Management (“SM”) Subscription data from the UDM/UDR (see block 237).

At Step 8, the SMF 209 sends an Nudm_SDM_get service operation request to the UDM 211 requesting SM data for the UAV's Subscription Permanent Identifier (“SUPI”) (see messaging 239).

At Step 9, the UDM 211 responds with subscription data (see messaging 241). Note that the SM subscription data from the UDM includes UAV operation information, i.e., an indication of whether UUAA and/or C2 authorization is required.

At Step 10, the SMF 209 responds to the AMF 207 with a Create SM Context Ack (see messaging 243).

At Step 11, the SMF 209 determines from the SM Subscription data whether the PDU session requires UUAA and/or C2 authorization (see block 245). In one embodiment, the SMF 209 may also check its internal database if the provided PDU session ID or if the SUPI of the UE 201 (i.e., UAV) has a prior UUAA and/or C2 authorization. If no authorization exists, then steps 12 to 28 are carried out and the SMF 209 selects a UAS-NF 213 to start the authorization procedure.

At Step 12, the SMF 209 initiates the authorization procedure by sending a Nuavnf_UAV_Operations request (see messaging 247). In one embodiment, the request may include separate indications of whether UUAA and/or C2 authorization is required. In an alternative embodiment, separate service operations requests are used for UUAA and C2 authorization.

At Step 13, the UAS-NF 213 determines whether UUAA and/or C2 authorization is required for the UAV (see block 249). In one embodiment, the UAS-NF 213 may check its internal database to verify if the UE 201 (i.e., UAV) has a prior valid UUAA and/or C2 authorization. When there is no valid authorization—or when the UE 201 (i.e., UAV) did not provide a UAV container, then the UAS-NF 213 requests the UE 201 (i.e., UAV) to provide the required information. If UUAA is required, then the UAS-NF 213 requests the CAA Level UAV ID from the UE 201 (i.e., UAV). If C2 authorization is required, then the UAS-NF 213 requests CAA Level UAV ID and Flight Information.

At Step 14, the UAS-NF 213 sends the request to the UE 201 (i.e., UAV) via the AMF 207 by invoking an Namf_Communication_N1N2Messagetransfer service operation (see messaging 251). The request includes a UAV payload container that conveys the protocol that requests CAA-Level UAV ID and/or Flight Information.

At Step 15, the AMF 143 forwards the UAV Payload container to the UE 201 (i.e., UAV) via a DL NAS Transport message (see messaging 253). The DL NAS transport message includes the UAV payload. In one embodiment, the Payload Type IE of the DL NAS transport message is set to ‘UAV payload.”

At Step 16, the UE 201 (i.e., UAV) determines that the information needs to be sent to a corresponding UAV application (see block 255). The UAV application provides the requested information to the NAS layer.

Continuing on FIG. 2C, at Step 17, the UE 201 (e.g., the NAS layer in the UE 201) includes within a UL NAS Transport message a UAV payload container including the requested information (i.e., CAA Level UAV ID and/or Flight Authorization ID or Flight Information Details, if the UAV requests flight authorization within the PDU session establishment request according to step 2) (see messaging 257).

At Step 18, the AMF 207 forwards the UAV payload container to the UAS-NF 213 within a Namf_Communication_N1N2_messagetransfer notify message (see messaging 259).

At Step 19, the UAS-NF 213 optionally stores the authorization(s) in its internal database context for UA Vs/UEs that have been successfully authorized. The UAS-NF 213 may check the stored status (e.g., based on the SUPI) and determine whether this UE 201 (i.e., UAV) has a valid authorization (see block 261). If no valid authorization is stored, the UAS-NF 213 determines the external identifier of this UAV (e.g., 3GPP UAV ID), i.e., in order to initiate UAS authentication via the USS/UTM server 205. In one embodiment, the UAS-NF 213 determines the 3GPP UAV ID of the UE 201 (i.e., UAV) from the SUPI of the UE 201. In another embodiment, the UAS-NF 213 determines the 3GPP UAV ID from the CAA-Level UAV ID.

At Step 20, if the SUPI is used to obtain the 3GPP UAV ID, then the UAS-NF 213 sends an Nudm_SDM_Get service operation to the UDM 211 requesting Group Identifier Translation for the SUPI (see messaging 263).

At Step 21, the UDM 211 provides the 3GPP UAV ID to the UAS-NF 213 (see messaging 265). In some embodiments, the 3GPP UAV ID can include a Generic Public Subscription Identifier (GPSI) (e.g., an external identifier used by a 3GPP network that allows identification of a UAV 106 by a third party), among other identifiers and/or types of identifier that are possible and contemplated herein.

At Step 22, the UAS-NF 213 sends an Naf_UAV_Auth_request service operation including the CAA Level UAV ID, Flight Authorization ID, or Flight Info Details to a USS/UTM server 205, if provided in steps 5 or 17 (see messaging 267). In one embodiment, the request may be sent to the USS/UTM server 205 via an NEF 215. If the request is sent via the NEF 215, then the UAS-NF 213 includes in the message to the NEF 215 the address of the USS/UTM server 205.

Steps 23 to 28 are conditional and/or optional. For example, step 23 may be initiated in response to the USS/UTM server 205 requiring additional information and/or credentials from the UE 201 (i.e., the UAV) to, for example, authenticate the UAV 106. In response to the request for additional information and/or credentials, the UE 201 will provide the additional information and/or credentials, as detailed in steps 24 to 28 below. Alternatively, when the USS/UTM server 205 does not require additional information and/or credentials from the UE 201 (i.e., UAV), then Steps 23 to 28 are skipped.

At Step 23, if the USS/UTM server 205 requires additional authentication information from the UE 201 (i.e., UAV), then the USS/UTM server 205 invokes an Naf_UAV_Auth service operation to the UAS-NF 213 requesting the additional information, i.e., by sending a Naf_UAV_Auth_Response message (see messaging 269).

At Step 24, the UAS-NF 213 forwards the request for additional information to the AMF 207 within a UAV payload within an Namf_Communication_N1N2_Messagetransfer message (see messaging 271). In an alternative embodiment, the UAS-NF 213 may use a generic Nuavnf_UAV_Operations notify message that includes the UAV payload.

At Step 25, the AMF 207 forwards the UAV payload to the UE 201 in a DL NAS transport message (see messaging 273).

At Step 26, the UE 201 (i.e., the UAV) provides the requested information to the AMF 207, i.e., within a UAV payload in a UL NAS transport message (see messaging 275).

At Step 27, the AMF 207 forwards the UAV payload with the requested information to the UAS-NF 213 within an Namf_Communication_N1N2_messagetransfer notify message (see messaging 277). In an alternative embodiment, the UAV payload may be included in a generic Nuavnf_UAV_Operations notify message.

Continuing on FIG. 2D, at Step 28 the UAS-NF 213 forwards the requested information to the USS/UTM server 205 within a Naf_UAV_Auth_request (see messaging 279).

At Step 29, the USS/UTM server 205 authorizes the request (see block 281).

At Step 30, the USS/UTM server 205 determines remote identification and tracking information including an authorization token or assigns a flight authorization ID, if case 1 applies, i.e., there was no prior flight authorization (i.e., if step 2 has not been carried out) (see block 283).

At Step 31, the USS/UTM server 205 sends a Naf_UAV_Auth_response to the UAS-NF 213 with the authorization result that includes an authorization token and/or a flight authorization ID (see messaging 285).

At Step 32, the UAS-NF 213 stores the authorization result in its local database (see block 287). The internal database may include information that a 3GPP UAV identifier or a CAA-Level UAV identifier has a valid UUAA or C2 authorization.

At Step 33, the UAS-NF 213 sends an Nuavnf_UAV_operation response to the SMF 209 indicating that the PDU session is authorized to be established (see messaging 289).

At Step 34, the SMF 209 stores in SM context that the UE 201 and/or the PDU session ID is authorized for UUAA and/or C2 (see block 291).

At Step 35, the SMF 209 sends a PDU session establishment accept message to the UE 201 (i.e., UAV). The SMF 209 sends an Namf_N2N2_message transfer service operation to the AMF 207 including the PDU session ID and an N1 SM container (see messaging 293). The N1 SM container includes the PDU session accept message, which also includes within a UAV payload the Flight Authorization ID if the USS/UTM server 205 provided a flight authorization ID in step 25.

At Step 36, the AMF 207 forwards the PDU session accept message to the UE 201 (i.e., UAV) (see messaging 295). The procedure 200 ends.

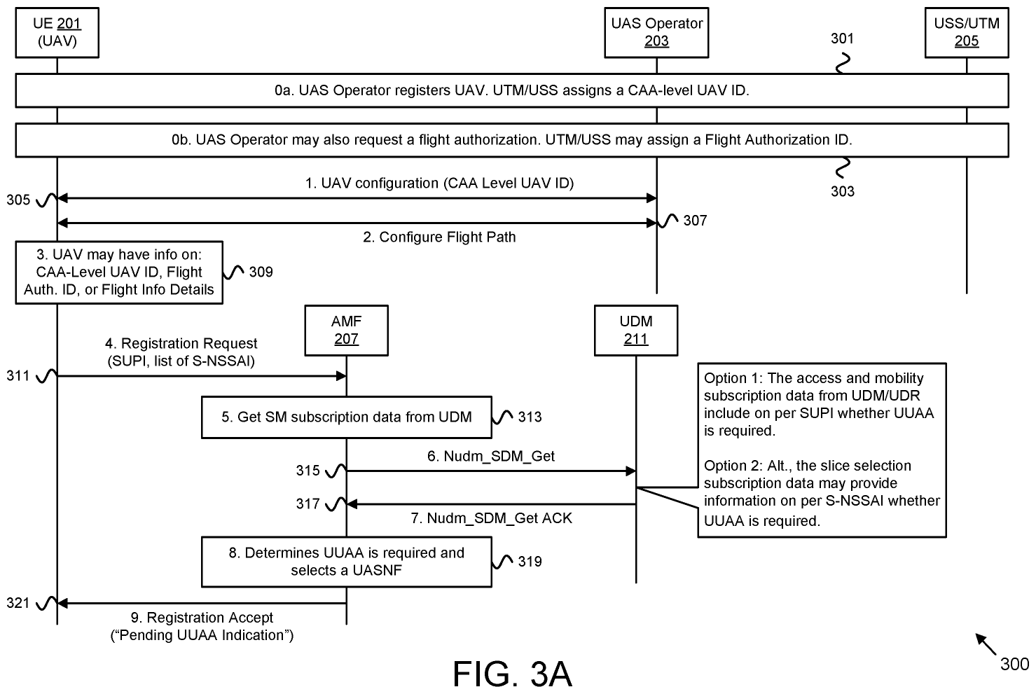

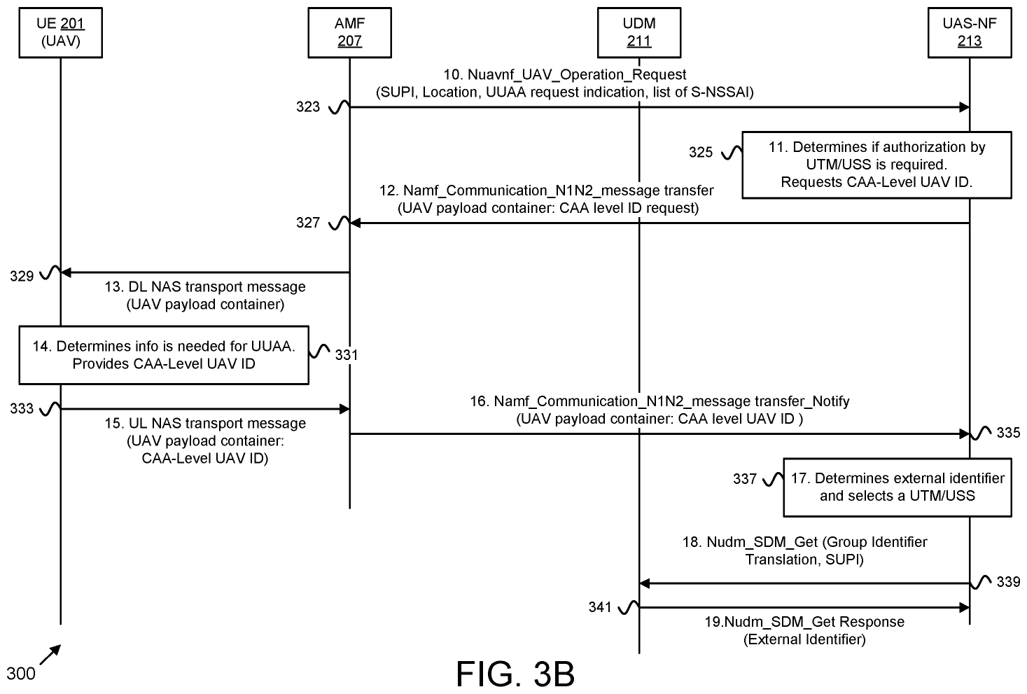

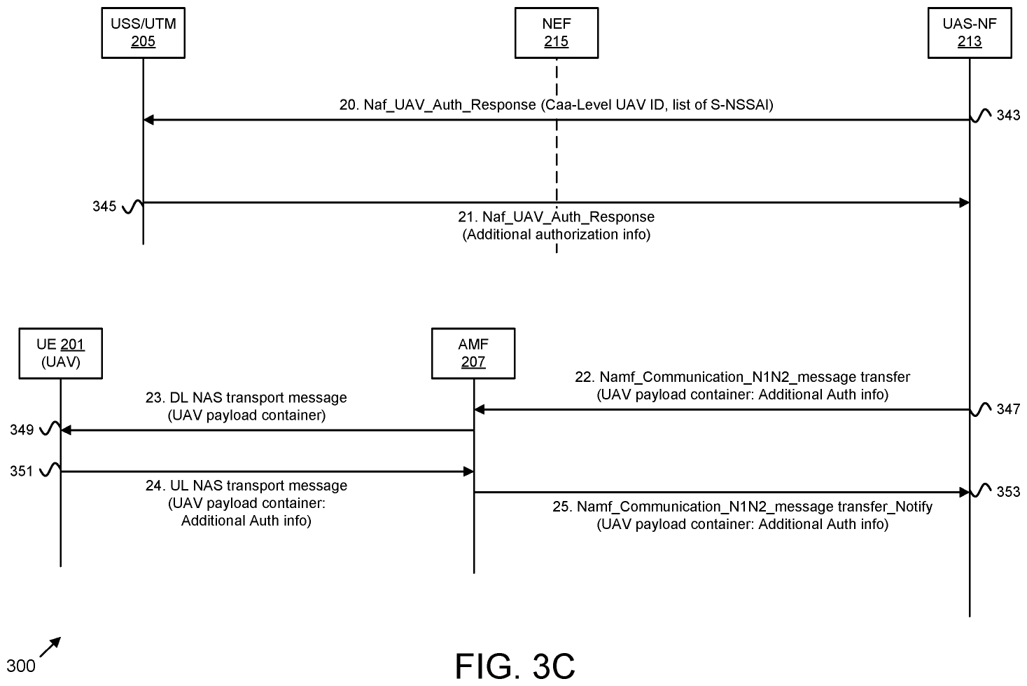

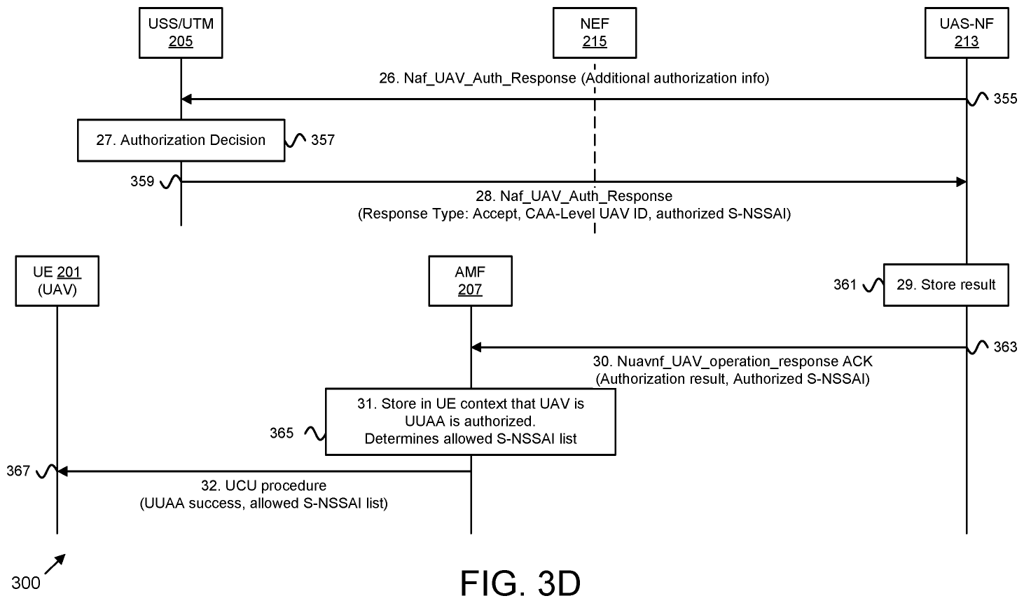

According to a second solution (see, e.g., FIGS. 3A through 3D), UUAA is supported at UAV/UE registration. A UAV (i.e., the UAV 106) registers to the 3GPP network using its SIM credentials, e.g., as specified in 3GPP TS 23.502. The UAV sends a Registration Request to an AMF (e.g., the AMF 143), which may include a list of S-NSSAIs. The AMF retrieves Access and Mobility subscription data and/or Slice Selection Subscription data to determine if a UUAA is required for the UAV. The Access and Mobility subscription data includes, on a per SUPI basis, whether UUAA is required. In an alternative embodiment, the Slice Selection Subscription Data may include on per SUPI and per S-NSSAI level if UUAA is required. This is shown in the following table.

TABLE 2
Example Access and Mobility Subscription Data and Slice Selection Subscription Data for UUAA

| Subscription | | |
|---|---|---|
| data type | Field | Description |
| Access and Mobility | GPSI List | List of the GPSI (Generic Public Subscription |
| Subscription data | | Identifier) used both inside and outside of the |
| (data needed for UE | | 3GPP system to address a 3GPP subscription. |
| Registration and | Internal Group ID-list | List of the subscribed internal group(s) that the |
| Mobility | | UE belongs to. |
| Management) | Subscribed-UE-AMBR | The Maximum Aggregated uplink and downlink |
| | | MBRs to be shared across all Non-GBR QoS |
| | | Flows according to the subscription of the user. |
| | Subscribed S-NSSAIs | The Network Slices that the UE subscribes to. In |
| | | the roaming case, it indicates the subscribed |
| | | Network Slices applicable to the Serving PLMN. |
| | Default S-NSSAIs | The Subscribed S-NSSAIs marked as default |
| | | S-NSSAI. In the roaming case, only those |
| | | applicable to the Serving PLMN. |
| | S-NSSAIs subject to Network | The Subscribed S-NSSAIs marked as subject to |
| | Slice-Specific Authentication | NSSAA. |
| | and Authorization | |
| | UE Usage Type | As defined in TS 23.501 [2], clause 5.15.7.2. |
| | RAT restriction | 3GPP Radio Access Technology(ies) not allowed |
| | | the UE to access. |
| | Forbidden area | Defines areas in which the UE is not permitted to |
| | | initiate any communication with the network. |
| | Service Area | Indicates Allowed areas in which the UE is |
| | Restriction | permitted to initiate communication with the |
| | | network, and Non-allowed areas in which the UE |
| | | and the network are not allowed to initiate Service |
| | | Request or SM signaling to obtain user services. |
| | Core Network type | Defines whether UE is allowed to connect to 5GC |
| | restriction | and/or EPC for this PLMN. |
| | CAG information | The CAG information includes Allowed CAG |
| | | list and, optionally an indication whether the |
| | | UE is only allowed to access 5GS via CAG |
| | | cells as defined in TS 23.501 [2], clause 5.30.3. |
| | CAG information | When present, indicates to the serving AMF that |
| | Subscription | the CAG information in the subscription data |
| | Change Indication | changed and the UE must be updated. |
| | RFSP Index | An index to specific RRM configuration in the NG- |
| | | RAN. |
| | Subscribed Periodic | Indicates a subscribed Periodic Registration |
| | Registration Timer | Timer value. |
| | MPS priority | Indicates the user is subscribed to MPS as |
| | | indicated in TS 23.501 [2], clause 5.16.5. |
| | MCX priority | Indicates the user is subscribed to MCX as |
| | | indicated in TS 23.501 [2], clause 5.16.6. |
| | AMF-Associated Expected | Information on expected UE movement and |
| | UE Behavior | communication characteristics. See |
| | parameters | clause 4.15.6.3 |
| | AMF-Associated Network | Information on UE specific network configuration |
| | Configuration parameters | parameters and their corresponding validity times. |
| | | See clause 4.15.6.3a. |
| | Steering of Roaming | List of preferred PLMN/access technology |
| | (“SoR”) | combinations or HPLMN indication that no change |
| | | of the “Operator Controlled PLMN Selector with |
| | | Access Technology” list stored in the UE is |
| | | needed (see NOTE 3). |
| | | Optionally includes an indication that the UDM |
| | | requests an acknowledgement of the reception of |
| | | this information from the UE. |
| | SoR Update Indicator | An indication whether the UDM requests the AMF |
| | for Initial | 143 to retrieve SoR information when the UE |
| | Registration | performs Registration with NAS Registration Type |
| | | “Initial Registration”. |
| | SoR Update Indicator | An indication whether the UDM requests the AMF |
| | for Emergency | 143 to retrieve SoR information when the UE |
| | Registration | performs Registration with NAS Registration Type |
| | | “Emergency Registration”. |
| | Network Slicing | When present, indicates to the serving AMF that |
| | Subscription | the subscription data for network slicing changed |
| | Change Indicator | and the UE configuration must be updated. |
| | Tracing Requirements | Trace requirements about a UE (e.g., trace |
| | | reference, address of the Trace Collection Entity, |
| | | etc.) is defined in TS 32.421 [39]. |
| | | This information is only sent to AMF in the |
| | | HPLMN or one of its equivalent PLMN(s). |
| | Inclusion of NSSAI in RRC | When present, it is used to indicate that the UE is |
| | Connection Establishment | allowed to include NSSAI in the RRC connection |
| | Allowed | Establishment in clear text for 3GPP access. |
| | Service | Used to set the Service Gap timer for Service Gap |
| | Gap Time | Control (see TS 23.501 [2] clause 5.31.16). |
| | Subscribed | List of the subscribed DNNs for the UE used to |
| | DNN list | determine the list of LADN available to the UE as |
| | | defined in clause 5.6.5 of TS 23.501 [2]. |
| | UDM Update | Includes a set of parameters (e.g., updated |
| | Data | Default Configured NSSAI and/or updated |
| | | Routing Indicator) to be delivered from UDM to |
| | | the UE via NAS signaling as defined in |
| | | clause 4.20 (NOTE 3). |
| | | Optionally includes an indication that the UDM |
| | | requests an acknowledgement of the reception of |
| | | this information from the UE and an indication for |
| | | the UE to re-register. |
| | NB-IoT UE | Numerical value used by the NG-RAN to prioritize |
| | priority | between UEs accessing via NB-IoT. |
| | Enhanced Coverage | Specifies whether CE mode B is restricted for the |
| | Restriction | UE, or both CE mode A and CE mode B are |
| | | restricted for the UE, or both CE mode A and CE |
| | | mode B are not restricted for the UE. |
| | IAB-Operation | Indicates that the subscriber is allowed for IAB- |
| | allowed | operation as specified in TS 23.501 [2] |
| | | clause 5.35.2. |
| | Charging | It contains the Charging Characteristics as |
| | Characteristics | defined in Annex A, clause A.1 of TS 32.256 [71]. |
| | Extended idle mode | Indicates a subscribed extended idle mode DRX |
| | DRX cycle length | cycle length value. |
| | UUAA indication (new) | Indicates registration accept is subject to UUAA |
| | | successful. |
| Slice Selection | Subscribed S-NSSAIs | The Network Slices that the UE subscribes to. In |
| Subscription data | | roaming case, it indicates the subscribed network |
| (data needed for | | slices applicable to the serving PLMN. |
| | Default S-NSSAIs | The Subscribed S-NSSAIs marked as default S- |
| | | NSSAI. In the roaming case, only those applicable |
| | | to the Serving PLMN. |
| | S-NSSAIs subject to Network | The Subscribed S-NSSAIs marked as subject to |
| | Slice-Specific Authentication | NSSAA. |
| | and Authorization | |
| | S-NSSAIs subject to UUAA | The S-SNSSAIs marked as subject to UUAA |
| | (new) | |

In various embodiments, the AMF determines if there is a valid prior UUAA authorization for this UAV by checking the UE context. If there is no valid authorization, the AMF selects a UAS-NF (i.e., the UAS-NF 147) and starts the UUAA procedure by invoking a Nuavnf_UAV_operation request indicating that a UUAA is required. Alternatively, a specific service operation for UUAA is used. The message includes the SUPI and the current UAV location and the list of requested S-NSSAIs if provided by the UAV and the slice selection subscription data indicating that the S-NSSAIs are subject to UUAA. When the AMF determines that a UUAA is required, the AMF sends an indication to the UAV in a Registration Accept message that the UUAA is pending.

The UAS-NF determines if UUAA is required for the UAV by checking if there is an existing valid UUAA for this UAV in its internal database. If a UUAA is required for this UAV, the UAS-NF requests that the UAV provide the required information to support a UUAA (i.e., to provide CAA-Level UAV ID).

The protocol defined in the above first solution may then be re-used. The UAS-NF UAV exchange information via the AMF by utilizing the and Namf_Communication_N1N2_messagetransfer and DL/UL NAS transport messages.

When the UAS-NF obtains the information, the UAS-NF selects a USS/UTM server and initiates the authorization procedure by invoking the Naf_UAV_Auth_request service operation. The message includes the CAA-Level UAV ID, 3GPP UAV ID. In one embodiment, if the UUAA is carried out at the S-NSSAI level, the message also includes the list of S-NSSAIs requested by the UAV.

The message, in some embodiments, may be transported via an NEF. The USS/UTM server authorizes the request and provides the response to the UAS-NF. If the UUAA is carried out at the S-NSSAI level, the USS/UTM server provides a list of the authorized S-NSSAIs. The UAS-NF stores the authorization results in its local database, i.e., stores that the CAA-Level UAV ID and 3GPP UAV ID have a valid UUAA. The UAS-NF responds to the AMF with the authorization result within a Nuavnf_UAV_operation response message. The AMF stores in the UE context that the UAV has a valid UUAA (e.g., stores that the SUPI has a valid UUAA).

If the UUAA is carried out at the S-NSSAI level, the AMF determines the allowed S-NSSAI list based on the authorized S-NSSAIs provided by the USS/UTM. The AMF sends a UE Configuration Update to the UAV indicating a UUAA success and also including the list of allowed S-NSSAIs.

FIGS. 3A through 3D depict a procedure 300 for a UAS-NF to obtain the required information from a UAV, according to the embodiments of the second solution. The procedure 300 involves the UE 201 (e.g., the Aerial UE of a UAV and one embodiment of the remote unit 105), the UAS operator 203 (e.g., one embodiment of the UAS operator 103), the USS/UTM server 205 (e.g., one embodiment of the USS/UTM 157), the AMF 207 (e.g., one embodiment of the AMF 143), the SMF 209 (e.g., one embodiment of the SMF 145), the UDM 211 (e.g., one embodiment of the UDM/UDR 149), the UAS-NF 213 (e.g., one embodiment of the UAS-NF 147), and the NEF 215 (e.g., one embodiment of the NEF 146). The steps of the procedure 300 are described as follows.

Beginning on FIG. 3A, as a precondition, at Step 0a the UAS Operator 203 registers a UAS (e.g., a UAV 106 and a UAV controller 108) to a USS provider (e.g., USS/UTM server 205) (see messaging 301). The USS provider (e.g., USS/UTM server 205) assigns a CAA-Level UAV ID to the UAV (i.e., to the UE 201).

As an optional precondition, the UAS operator 203 may request a flight authorization from its USS provider (i.e., USS/UTM server 205) (see block 303). The USS/UTM server 205 may assign a Flight Authorization ID for the authorized flight.

At Step 1, the UAS operator 203 assigns the CAA-Level UAV ID to the UE 201 (i.e., UAV) (see messaging 305). Alternatively, the CAA-Level UAV ID may be assigned by the UTM or USS provider (i.e., USS/UTM server 205) to the UE 201 (i.e., UAV) via IP connectivity or via NAS signaling.

At Step 2, the UAS operator 203 may configure and convey flight information to the UE 201 (i.e., UAV) (see messaging 307). The flight information may include the flight Authorization ID for the authorized flight (e.g., if step Ob has been carried out) or alternatively includes UAV aviation information (e.g., Flight Path information, Pilot name, time of flight, etc.).

At Step 3, based on steps 1 and 2, the UE 201 (i.e., UAV) has information on CAA-Level UAV ID, Flight Authorization ID and/or UAV aviation information (see block 309).

At Step 4, the UE 201 (i.e., UAV) initiates an initial registration procedure to the 3GPP network (e.g., an AMF 207), e.g., using standard procedures defined in 3GPP TS 23.502 (see messaging 311). The UE 201 (i.e., UAV) may also include a list of the S-NSSAIs in the request.

At Step 5, the AMF 207 determines to retrieve the Access and Mobility and Slice Selection Subscription Data for the UAV's SUPI from the UDM/UDR (see block 313).

At Step 6, the AMF 207 invokes an Nudm_SDM_Get service operation to the UDM 211 requesting Access and Mobility and Slice Selection Subscription data for the UAV's SUPI (see messaging 315).

At Step 7, the UDM 211 provides the subscription data to the AMF 207 in the response (see messaging 317). The subscription data may indicate if a UUAA is required and/or whether some S-NSSAIs are subject to the UUAA. According to a first option, the access and mobility subscription data from the UDM/UDR indicates on a per-SUPI level whether UUAA (or other UAS authorization) is required. According to a second option, the slice selection subscription data may provide information on a per-slice (i.e., per-S-NSSAI) level of whether UUAA (or other UAS authorization) is required.

At Step 8, the AMF 207 determines whether UUAA (or other UAS-related authorization) is required, e.g., checking if there is a valid UUAA authorization for the UE 201 (i.e., UAV) by checking the UE context (see block 319). If there is no valid authorization, then steps 10 to 22 are carried out and the AMF 207 also selects a UAS-NF 213 at Step 8.

At Step 9, the AMF 207 sends a registration accept to the UE 201 (i.e., UAV) indicating that the required UUAA is pending (see messaging 321).

Continuing on FIG. 3B, at Step 10 the AMF 207 initiates a Nuavnf_UAV_Operations request to the selected UAS-NF 213 (see messaging 323). The request may include indication of whether a UUAA is required and a list of the requested S-NSSAIs if the UAV 106 provided a list of requested S-NSSAIs in step 4 and the Slice Selection Subscription data indicates that the S-NSSAIs are subject to the UUAA.

At Step 11, the UAS-NF 213 receives the request. The UAS-NF 213 determines if authorization by UTM/USS is required, e.g., by checking internally whether the UE 201 (i.e., UAV) has a prior UUAA authorization (see block 325). If there is no prior authorization, then the UAS-NF 213 requests that the UE 201 (i.e., UAV) provide the CAA-Level UAV ID to the UAS-NF 213.

At Step 12, the UAS-NF 213 sends the request to the UE 201 (i.e., UAV) via the AMF 207 by invoking a Namf_Communication_N1N2Messagetransfer service operation (see messaging 327). The request includes a UAV payload container that conveys the protocol requesting the CAA-Level UAV ID.

At Step 13, the AMF 207 forwards the UAV Payload container to the UE 201 (i.e., UAV) via a DL NAS Transport message (see messaging 329). The DL NAS transport message includes the UAV payload. In certain embodiments, the Payload Type IE of the DL NAS transport message is set to ‘UAV payload.”

At Step 14, the UE 201 (i.e., UAV) determines which information needs to be sent to the UAV application (see block 331). The UAV provides the requested information, i.e., the CAA-level UAV ID.

At Step 15, the UE 201 (i.e., UAV) includes within a UL NAS Transport message to the AMF 207 a UAV payload container including the requested information (e.g., a CAA Level UAV ID) (see messaging 333).

At Step 16, the AMF 207 forwards the UAV payload container within a Namf_Communication_N1N2_messagetransfer notify message to the UAS-NF 213 (see messaging 335).

At Step 17, the UAS-NF 213 determines the external identifier of this UAV (e.g., a 3GPP UAV ID) from the SUPI of the UE 201 (i.e., UAV) (see block 337). In one embodiment, the UAS-NF 213 determines the 3GPP UAV ID from the CAA-Level UAV ID for the UAV.

At Step 18, if the SUPI of the UE 201 (i.e., UAV) is used to obtain the 3GPP UAV ID, then the UAS-NF 213 sends an Nudm_SDM_Get service operation to the UDM 211 requesting a Group Identifier Translation of the SUPI (see messaging 339).

At Step 19, the UDM 211 provides the 3GPP UAV ID to the UAS-NF 213 (see messaging 341).

Continuing on FIG. 3C, at Step 20, the UAS-NF 213 sends an Naf_UAV_Auth_request service operation to the USS/UTM server 205 that includes the CAA Level UAV ID and the list of S-NSSAIs if the S-NSSAIs were provided in step 4 and the slice level subscription data indicates that the S-NSSAIs are subject to the UUAA (see messaging 343). In one embodiment, the request may be sent to a USS/UTM server 205 via an NEF 215. If the request is sent via the NEF 215, then the UAS-NF 213 includes in the message to the NEF 215 the address of the USS/UTM server 205.

Steps 21 to 26 are conditional and/or optional. For example, step 21 may be initiated in response to the USS/UTM server 205 requiring additional information and/or credentials from the UE 201 (i.e., the UAV) to, for example, authenticate the UAV 106. In response to the request for additional information and/or credentials, the UE 201 will provide the additional information and/or credentials, as detailed in steps 24 to 26 below. Alternatively, when the USS/UTM server 205 does not require additional information and/or credentials from the UE 201 (i.e., UAV), then Steps 21 to 26 are skipped.

At Step 21, if the USS/UTM server 205 requires additional authentication information from the UE 201 (i.e., UAV), then the USS/UTM server 205 invokes a Naf_UAV_Auth_response to the UAS-NF 213 requesting the additional information (see messaging 345).

At Step 22, the UAS-NF 213 forwards the request for additional information to the AMF 207 within a UAV payload within an Namf_Communication_N1N2_Messagetransfer message (see messaging 347). In an alternative embodiment, the UAV payload may be included in a generic Nuavnf_UAV_Operations notify message.

At Step 23, the AMF 207 forwards the UAV payload to the UE 201 (i.e., UAV) in a NAS transport message (see messaging 349).

At Step 24, the UE 201 (i.e., UAV) provides the requested information to the AMF 207 within a UAV payload in UL NAS transport message (see messaging 351).

At Step 25, the AMF 207 forwards the UAV payload with the requested information to the UAS-NF 213 within an Namf_Communication_N1N2_messagetransfer notify message (see messaging 353). In an alternative embodiment, the UAV payload may be included in a generic Nuavnf_UAV_Operations notify message.

Continuing on FIG. 3D, at Step 26 the UAS-NF 213 forwards the requested information to the USS/UTM server 205 within a Naf_UAV_Auth_response (see messaging 355).

At Step 27, the USS/UTM server 205 authorizes the request (see block 357).

At Step 28, the USS/UTM server 205 provides the UAV authorization to the UAS-NF 213 (see messaging 359). The response may include a list of authorized S-NSSAIs if S-NSSAIs are included in step 20.

At Step 29, the UAS-NF 213 stores the authorization result in its local database (see block 361). The UAS-NF 213 may store internally that a CAA-Level UAV ID or 3GPP UAV ID is UUAA authorized.

At Step 30, the UAS-NF 213 responds to the AMF 207 with a Nuavnf_UAV_Operations response message indicating that the UUAA is successful (see messaging 363). The message may include the list of authorized S-NSSAI if the S-NSSAIs were provided in step 22.

At Step 31, the AMF 207 stores in the UE context that UUAA is successful and determines a list of allowed S-NSSAI based on the authorized S-NSSAIs if the S-NSSAIs were received in step 24 (see block 365).

At Step 32, the AMF 143 indicates to the UE 201 (i.e., UAV) within a UE Configuration Update procedure that the UUAA was successful and provides a list of allowed and/or authorized S-NSSAIs based on step 25 (see messaging 367). The procedure 300 ends.

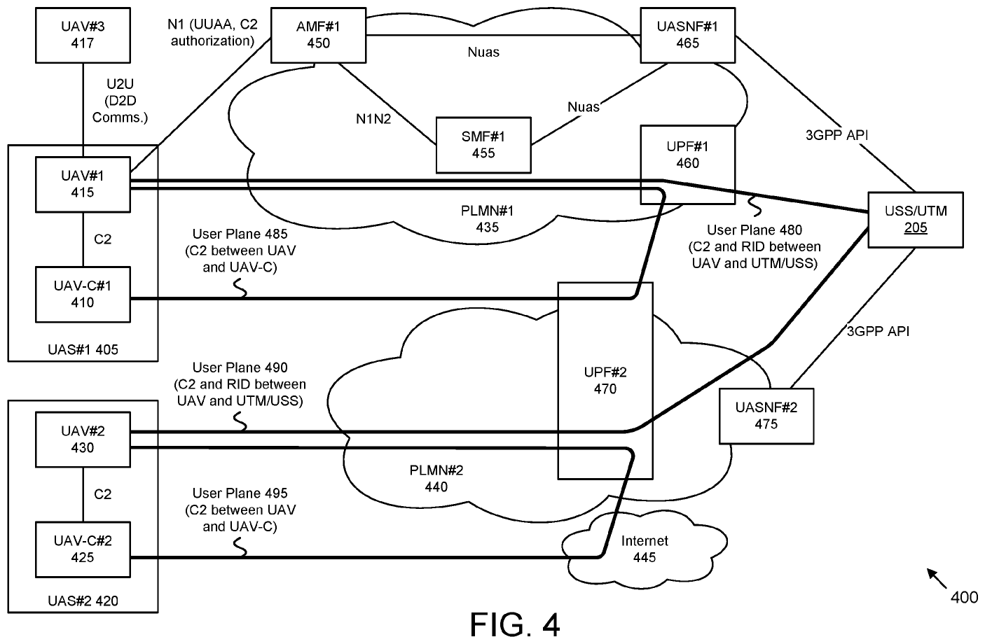

FIG. 4 depicts a network architecture 400 for support of UAS in a 3GPP system. The UAV and the UAV-C (or sometimes shown as UAS) are considered as User Equipment (UE) according to the 3GPP definition implementing in addition UAV application(s).

The main elements to support UAS in a 3GPP system include the UAS-NF, the UAV and UAV-C. The UAS-NF exposes to UTM (UAS Traffic Management) and/or USS (UAS Service Supplier) location information about the UAV utilizing 3GPP LCS and/or presence reporting information from the AMF. The UAS-NF interfaces with a USS/UTM server for UAV Authentication & Authorization (e.g., UUAA), authorizing a UAV to carry out UAV operations via the 3GPP network. The UAS-NF may also be involved with the C2 Authentication/Pairing procedures. The UAS-NF may receive C2 pairing routing rules from the USS/UTM server 205, e.g., via 3GPP API.

As depicted in FIG. 4, in some embodiments the UAS-NF interacts with the USS/UTM server 205 via a 3GPP API. As described above, the USS/UTM server 205 may invoke a UAS-NF service operation. While not depicted in FIG. 4, the UAS-NF may interact with the USS/UTM server 205 via a NEF.

The UAS (which includes a UAV and a UAV-C) establishes user plane connectivity with a USS/UTM server 255 for providing remote identification and tracking information. The UAS establishes user plane connectivity between the UAV-C and the UAV for Command & Control (C2). In certain embodiments, a UAV (i.e., UAV #1 415) may establish a UAV-to-UAV connection (i.e., device-to-device communication) with a peer UAV (i.e., the UAV #3 417).

A requirement is that the UAS has already registered to a USS provider. In addition, the UAS must have a valid flight authorization provided by a USS provider.

FIG. 4 depicts different implementations of a UAS. In a first implementation, illustrated by UAS #1 405, a UAS may comprise a UAV (i.e., UAV #1 415) that establishes a connection (e.g., PDU Session) with a first PLMN (i.e., PLMN #1 435) and a networked controller (i.e., UAV-C #1 410) that has a connection (e.g., PDU Session) via a different PLMN (i.e., PLMN #2 440). In a second implementation, illustrated by UAS #2 420, a UAS may comprise a UAV (i.e., UAV #2 430) that establishes a connection (e.g., PDU Session) with PLMN (i.e., PLMN #2 440) and a non-networked controller (i.e., UAV-C #2 435) that has a connection that is outside any 3GPP network (i.e., UAV-C #2 connects via the internet 445). The term “networked UAV-C” refers to a UAV-C that is registered with a 3GPP network/PLMN, while the term “non-networked UAV-C” refers to a UAV-C that is not registered with a 3GPP network/PLMN.

A UAV establishes a connection to a USS/UTM server 205, e.g., for UUAA and/or C2 authentication as described above with reference to FIGS. 2A-2D and 3A-3D. After UUAA and C2 authentication (e.g., via the UASNF #1 465 in the PLMN #1 435), the UAV #1 415 establishes a user plane connection 480 with the USS/UTM 205 for C2 and/or Remote Identification and Tracking (“RID”). Additionally, the UAV #1 415 establishes a user plane connection 485 with the UAV-C #1 410 for C2. Note that the user plane connection 480 is established via the UPF #1 460 in the PLMN #1 435, while the user plane connection 485 is established via the UPF #1 460 in the PLMN #1 435 and also via the UPF #2 470 in the PLMN #2 440.

Similarly, after UUAA and C2 authentication (e.g., via the UASNF #2 475 in the PLMN #2 440), the UAV #2 430 establishes a user plane connection 490 with the USS/UTM 205 for C2 and/or Remote Identification and Tracking (“RID”) and also establishes a user plane connection 495 with the UAV-C #2 425 for C2. Note that the user plane connection 480 is established via the UPF #2 470 in the PLMN #2 440, while the user plane connection 485 is established via the UPF #2 470 in the PLMN #2 440 and also via the internet 445.

As depicted, the PLMN #1 435 includes a first AMF (i.e., AMF #1) 450 and first SMF (i.e., SMF #1) 455. The AMF #1 establishes an NAS connection with an Aerial UE in the UAV #1 415. The SMF #1 perform session management functions for the UAV #1 415. When performing UUAA and/or C2 authorization, messages between the UAV #1 415 and AMF #1 450 pass via the N1 interface. When performing UUAA and/or C2 authorization, messages between the AMF #1 450 and SMF #1 455 may use the N1N2 service-based interface. When performing UUAA and/or C2 authorization, messages between the AMF #1 450 and the UASNF #1 465—and messages between the SMF #1 455 and the UASNF #1 465—may use the Nuas service-based interface.

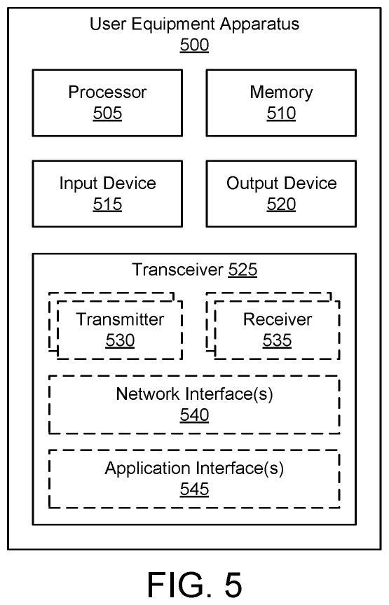

FIG. 5 depicts a user equipment apparatus 500 (or “UE apparatus 500”) that may be used for exchanging UAV credentials between a UAV 106 and 3GPP network for UAV authorization, according to embodiments of the disclosure. In various embodiments, the user equipment apparatus 500 is used to implement one or more of the solutions described above. The user equipment apparatus 500 may be one embodiment of the remote unit 105, UAV 106, UAV-C 108, and/or the UE, described above. Furthermore, the user equipment apparatus 500 may include, among other components, a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more cells supported by one or more base units 121. Additionally, the transceiver 525 may support at least one network interface 540 and/or application interface 545. The application interface(s) 545 may support one or more APIs. The network interface(s) 540 may support 3GPP reference points, such as Uu, N1, N2, N3, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the processor 505 controls the user equipment apparatus 500 to implement UE (e.g., UAV 106) behavior according to one or more of the above-described embodiments.

The memory 510, in one embodiment, includes a computer-readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to exchanging UAV credentials between a UAV 106 and 3GPP network for UAV authorization. For example, the memory 510 may store various parameters, configurations, policies, and the like as described above. In certain embodiments, the memory 510 also stores program code and related data, such as an operating system or other controller algorithms operating on the apparatus 500.

The input device 515, in one embodiment, may include any known computer input device including, but not limited to, a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime, etc.). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more network functions of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least transmitter 530 and at least one receiver 535. One or more transmitters 530 may be used to provide UL communication signals to a base unit 50, such as the UL transmissions described herein. Similarly, one or more receivers 535 may be used to receive DL communication signals from the base unit 121, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an ASIC, or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

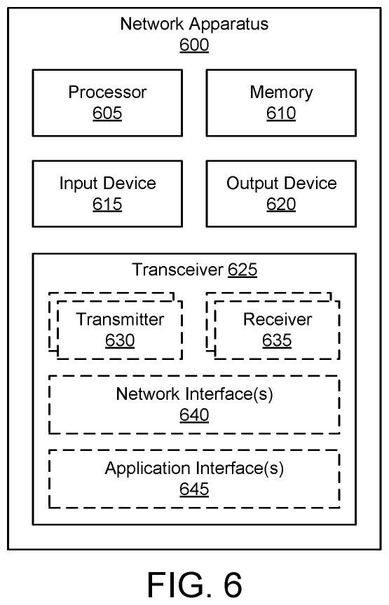

FIG. 6 depicts a network equipment apparatus 600 that may be used for exchanging UAV credentials between a UAV 106 and 3GPP network for UAV authorization, according to embodiments of the disclosure. The network equipment apparatus 600 may be one embodiment of the AMF 143, SMF 145, UAS-NF 147, UDM/UDR 149, or USS/UTM 157, described above. Furthermore, the base network equipment apparatus 600 may include a processor 605, a memory 610, an input device 615, an output device 620, and a transceiver 625. In some embodiments, the input device 615 and the output device 620 are combined into a single device, such as a touchscreen. In certain embodiments, the network equipment apparatus 600 may not include any input device 615 and/or output device 620. In various embodiments, the network equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more core network functions, RAN nodes, and/or service platforms. Additionally, the transceiver 625 may support at least one network interface 640 and/or application interface 645. The application interface(s) 645 may support one or more APIs, such as the 3GPP APIs used for communication between a UTM/USS and a UAS-NF. The network interface(s) 640 may support 3GPP reference points, such as N1, N2, N3, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the network equipment apparatus 600 is an UAS-NF 147, as described herein. Here, the processor 605 controls the network equipment apparatus 600 to perform the above described UAS-NF 147 behaviors. In other embodiments, the network equipment apparatus 600 is an AMF and/or SMF, as described herein. Here, the processor 605 controls the network equipment apparatus 600 to perform the above-described AMF and/or SMF behaviors.

The memory 610, in one embodiment, includes a computer-readable storage medium. In some embodiments, the memory 610 includes volatile computer storage media. For example, the memory 610 may include a random access memory (“RAM”), including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to exchanging UAV credentials between a UAV 106 and 3GPP network for UAV authorization. For example, the memory 610 may store various parameters, configurations, policies, and the like as described above. In certain embodiments, the memory 610 also stores program code and related data, such as an operating system or other controller algorithms operating on the network equipment apparatus 600.

The input device 615, in one embodiment, may include any known computer input device including, but not limited to, a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. One or more sets of transmitters 630 and receivers 635 may be used to communicate with the UE 105, as described herein. Similarly, one or more sets of transmitters 630 and receivers 635 may be used to communicate with network functions in the PLMN and/or RAN 120, as described herein. Although only one transmitter 630 and one receiver 635 are illustrated, the network equipment apparatus 600 may have any suitable number of transmitters 630 and receivers 635. Further, the transmitter(s) 630 and the receiver(s) 635 may be any suitable type of transmitters and receivers.

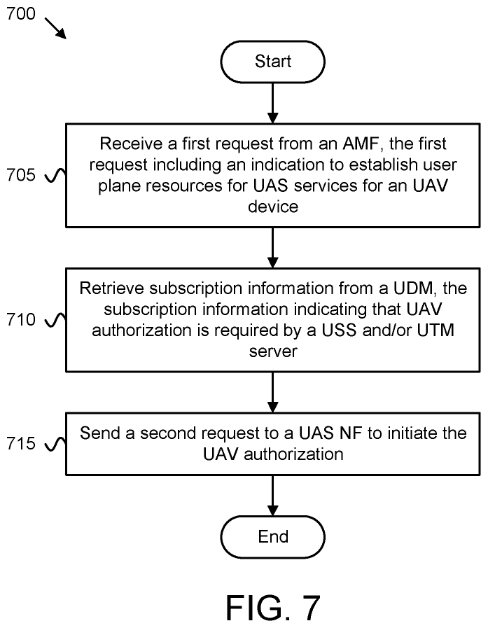

FIG. 7 is a flowchart diagram of one embodiment of a method 700 for receiving UAV authorization for a UAV 106. The method 700 may be performed by a network function in a mobile communication network, such as the SMF 145 and/or network equipment apparatus 600. In some embodiments, the method 700 may be performed by a processor executing program code, for example, a microcontroller, a microprocessor, a CPU, a GPU, an auxiliary processing unit, a FPGA, or the like.

The method 700 includes receiving 705 a first request from an AMF 143. In some embodiments, the request includes an indication to establish user plane resources for UAS services for a UAV device 106.

The method 700 further includes retrieving 710 subscription information from a UDM 149. The subscription information includes an indication that UAV authorization is required by a USS 157 and/or UTM 157 server.

The method 700 includes sending 715 a second request for a UAS-NF 147 to initiate the UAV authorization. The method 700 ends.

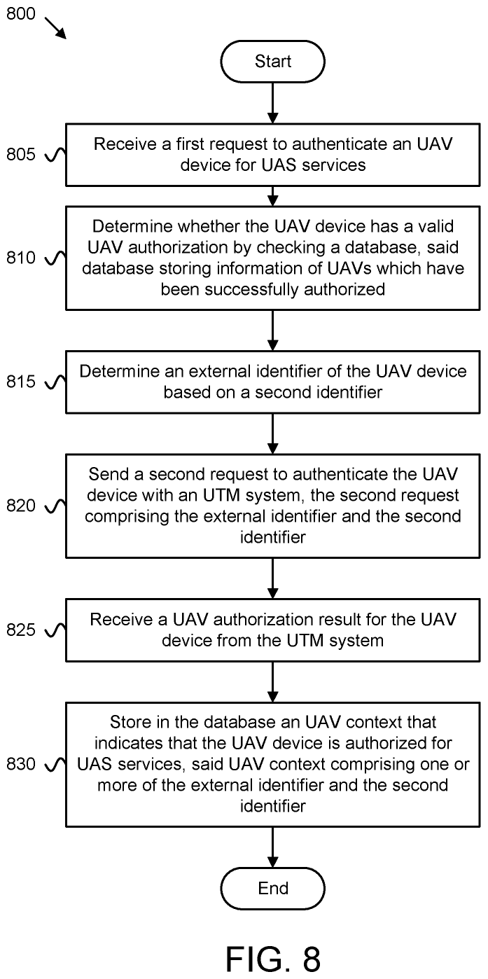

FIG. 8 is a flowchart diagram of another embodiment of a method 800 for receiving UAV authorization for a UAV 106. The method 800 may be performed by a network function in a mobile communication network, such as a UAS-NF 147 and/or network equipment apparatus 600. In some embodiments, the method 800 may be performed by a processor executing program code, for example, a microcontroller, a microprocessor, a CPU, a GPU, an auxiliary processing unit, a FPGA, or the like.

The method 800 includes receiving 805 a first request to authenticate a UAV device 106 for UAS services and determining 810 whether the UAV device 106 has a valid UAV authorization by checking a database storing information of UAVs that have been successfully authorized. The method 800 further includes determining 815 an external identifier of the UAV device 106 based on a second identifier. The method 800 includes sending 820 a second request to authenticate the UAV device with a UTM 157 system in which the second request comprises the external identifier and the second identifier.

The method 800 also includes receiving 825 a UAV authorization result for the UAV device 106 from the UTM 157 system and storing 830 in the database an UAV context that indicates that the UAV device 106 is authorized for UAS services in which said UAV context comprises one or more of the external identifier and the second identifier. The method 800 ends.

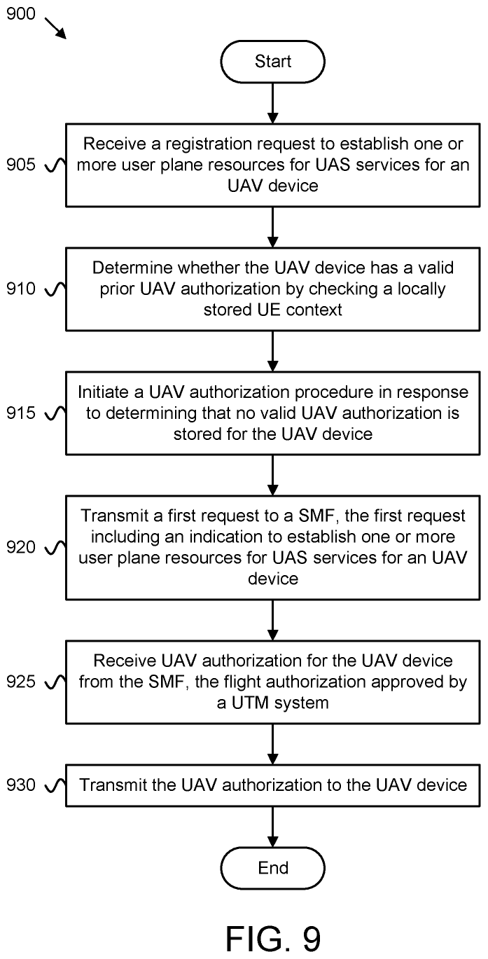

FIG. 9 is a flowchart diagram of another embodiment of a method 900 for receiving UAV authorization for a UAV 106. The method 900 may be performed by a network function in a mobile communication network, such as an AMF 143 and/or network equipment apparatus 600. In some embodiments, the method 900 may be performed by a processor executing program code, for example, a microcontroller, a microprocessor, a CPU, a GPU, an auxiliary processing unit, a FPGA, or the like.

The method 900 includes receiving 905 a registration request to establish one or more user plane resources for UAS services for a UAV device 106 and determining 910 whether the UAV device 106 has a valid prior UAV authorization by checking a locally stored User Equipment (“UE”) context. The method 900 further includes initiating 915 a UAV authorization procedure in response to determining that no valid UAV authorization is stored for the UAV device and transmitting 920 a first request to an SMF 145 in which the first request includes an indication to establish one or more user plane resources for UAS services for a UAV device 106.

The method 900 further includes receiving 925 UAV authorization for the UAV device 106 from the SMF 145 in which the UAV authorization is approved by a UTM 157 system and transmitting 930 the UAV authorization to the UAV device 930. The method 900 ends.

Disclosed herein is a first apparatus for receiving UAV authorization for a UAV 106 or 201, according to embodiments of the disclosure. The first apparatus may be implemented by a communication apparatus in a mobile communication network, such as an SMF 145, an SMF 209, and an SMF 460, described above. The first apparatus includes a transceiver for communicating with an AMF 143, an AMF 207, an AMF 455, a UDM 149, a UDM 211, a UAS-NF 147, a UAS-NF 213, a UASNF #1 465, the UASNF #2 475, a USS/UTM server 157, and/or a USS/UTM server 205, as described above. The first apparatus further includes a processor that interacts with and performs various operations with the AMF 143, the AMF 207, the AMF 455, the UDM 149, the UDM 211, the UAS-NF 147, the UAS-NF 213, the UASNF #1 465, the UASNF #2 475, the USS/UTM server 157, and/or the USS/UTM server 205.

The processor, in various embodiments, is configured to receive a first request from the AMF 143, the AMF 207, or the AMF 455 in which the first request includes an indication to establish user plane resources for UAS services for a UAV device 106, 201. The processor retrieves subscription information from a UDM node 149 or 211 in which the subscription information indicates that UAV authorization is required by a USS and/or UTM server 157, 205. The processor further sends a second request to a UAS-NF 147, 213 to initiate the UAV authorization.

In some embodiments, the UAV authorization comprises a Command and Control (“C2”) authorization for the UAV device 106, 201 and/or a UUAA for the UAV device 106, 201. In certain embodiments, the second request includes an indication of whether authorization is for C2 operation and/or for UUAA.

The first request, in some embodiments, comprises a UAV identifier and/or flight authorization information. In certain embodiments, the transceiver receives an authorization response that comprises a UAV authorization token and/or a flight authorization identifier. In additional embodiments, the second request to the UAS-NF 147, 213 includes an address of the USS/UTM server 157, 205 for authorization, the UAV identifier, and the flight authorization information provided by the UAV 106, 201.

In some embodiments, the subscription information from the UDM 149, 211 comprises Session Management subscription data. The Session management subscription data comprises network slice-level data and the Session management subscription data contains, for each DNN, an indication of whether a request to establish user plane resources requires UAV authorization from the USS/UTM server 157, 205.

In additional embodiments, the processor is further configured to determine whether valid UAV authorization information for the UAV device 106, 201 is stored in a local memory and store, in local memory, a Session Management (“SM”) context that indicates that the UAV device 106, 201 is authorized for UAV operation in response to receiving an authorization response from the UAS-NF 147, 213. In some embodiments, retrieving the subscription information data from the UDM 149, 211 occurs in response to determining that no valid UAV authorization information for the UAV 106, 201 is stored in the local memory.

The authorization response (e.g., containing UAV authorization), in some embodiments, is contained within a UAS payload received from the USS/UTM server 157, 205 via the UAS-NF 147, 213. In some embodiments, the UAS payload includes a UAV authorization result for the UAV 106, 201 for one or more network slices.

Disclosed herein is a first method for receiving UAV authorization for a UAV 106 or 201, according to embodiments of the disclosure. The first method may be performed by a communication apparatus in a mobile communication network, such as an SMF 145, an SMF 209, and an SMF 460 interacting with an AMF 143, an AMF 207, an AMF 455, a UDM 149, a UDM 211, a UAS-NF 147, a UAS-NF 213, a UASNF #1 465, the UASNF #2 475, a USS/UTM server 157, and/or a USS/UTM server 205, as described above.

The first method, in various embodiments, includes receiving a first request from the AMF 143, the AMF 207, or the AMF 455 in which the first request includes an indication to establish user plane resources for UAS services for a UAV device 106, 201. The first method further includes retrieving subscription information from a UDM node 149 or 211, in which the subscription information indicates that UAV authorization is required by a USS and/or UTM server 157, 205, and sending a second request to a UAS-NF 147, 213 to initiate the UAV authorization.

In some embodiments, the UAV authorization comprises a Command and Control (“C2”) authorization for the UAV device 106, 201 and/or a UUAA for the UAV device 106, 201. In certain embodiments, the second request includes an indication of whether authorization is for C2 operation and/or for UUAA.

The first request, in some embodiments, comprises a UAV identifier and/or flight authorization information. In certain embodiments, the first method includes receiving an authorization response that comprises a UAV authorization token and/or a flight authorization identifier. In additional embodiments, the second request to the UASNF 147, 213, 470 includes an address of the USS/UTM server 157, 205 for authorization, the UAV identifier, and the flight authorization information provided by the UAV 106, 201.

In some embodiments, the subscription information from the UDM 149, 211 comprises Session Management subscription data. The Session management subscription data comprises network slice-level data and the Session management subscription data contains, for each DNN, an indication of whether a request to establish user plane resources requires UAV authorization from the USS/UTM server 157, 205.

In additional embodiments, the first method further includes determining whether valid UAV authorization information for the UAV device 106, 201 is stored in a local memory and storing, in the local memory, a Session Management (“SM”) context that indicates that the UAV device 106, 201 is authorized for UAV operation in response to receiving an authorization response from the UAS-NF 147, 213. In some embodiments, retrieving the subscription information data from the UDM 149, 211 occurs in response to determining that no valid UAV authorization information for the UAV 106, 201 is stored in the local memory.

The authorization response (e.g., containing UAV authorization), in some embodiments, is contained within a UAS payload received from the USS/UTM server 157, 205 via the UAS-NF 147, 213. In some embodiments, the UAS payload includes a UAV authorization result for the UAV 106, 201 for one or more network slices.

Disclosed herein is a second apparatus for receiving UAV authorization for a UAV 106 or 201, according to embodiments of the disclosure. The second apparatus may be implemented by a communication apparatus in a mobile communication network, such as a UAS-NF 147, a UAS-NF 213, and a UASNF #1 465, the UASNF #2 475, a described above. The second apparatus includes a transceiver for communicating with an AMF 143, an AMF 207, an AMF 455, an SMF 145, an SMF 209, an SMF 460, a UDM 149, a UDM 211, a USS/UTM server 157, and/or a USS/UTM server 205, as described above. The second apparatus further includes a processor that interacts with and performs various operations with the AMF 143, the AMF 207, the AMF 455, the SMF 145, the SMF 209, the SMF 460, the UDM 149, the UDM 211, the USS/UTM system 157, and/or the USS/UTM system 205.

The processor, in various embodiments, is configured to receive a first request to authenticate an Unmanned Aerial Vehicle device 106, 201 for UAS services and determine whether the UAV device 106, 201 has a valid UAV authorization by checking a database storing information of UAVs that have been successfully authorized. The processor is further configured to determine an external identifier of the UAV device 106, 201 based on a second identifier and send a second request to authenticate the UAV device 106, 201 with a USS/UTM system 157, 205 in which the second request includes the external identifier and the second identifier. The processor also receives a UAV authorization result for the UAV device 106, 201 from the USS/UTM system 157, 205 and stores in the database an UAV context that indicates that the UAV device 106, 201 is authorized for UAS services. In certain embodiments, the UAV context includes the external identifier and/or the second identifier.

In further embodiments, the processor is further configured to transmit a first UAV payload container to the AMF 143, 207, 455 in which the first UAV payload container includes a third request for additional UAV information. The processor receives a second UAV payload container from the AMF 143, 207, 455 in which the second UAV payload container includes the requested additional UAV information and forwards the additional UAV information to the UAS-NF 147, 213. The UAV authorization for the UAV device 106, 201, in certain embodiments, is further based on the additional UAV information.

In some embodiments, the second identifier comprises a CAA-Level UAV identifier in which the database includes information that the CAA-Level UAV identifier has a valid authorization for the UAS services. Here, the processor further determines that the first request does not contain the CAA-Level UAV identifier and the processor sends a third request to retrieve the CAA-Level UAV identifier from the UAV device 106, 201.

In certain embodiments, retrieving the CAA-Level UAV identifier comprises transmitting a third request to an AMF 143, 207, 455 in response to determining that the UAV device 106, 201 is not authorized by the USS/UTM system 157, 205 and receiving the identifier for the UAV device 106, 201 and/or the flight information for the UAV device 106, 201 from the AMF 143, 207, 455. The third request, in some embodiments, requests an identifier for the UAV device 106, 201 and/or flight information for the UAV device 106, 201. In certain embodiments, the UAV authorization for the UAV device 106, 201 is based on the identifier for the UAV device and/or the flight information for the UAV device 106, 201.

The second identifier, in some embodiments, comprises a subscription permanent identifier (“SUPI”) and determining the external identifier comprises using the SUPI to retrieve the external identifier from a UDM node 149, 211.

In certain embodiments, the first request is received from an SMF 145, 209, 460 and the processor further transmits the UAV authorization result to the SMF 145, 209, 460. In further embodiments, the request for UAV authorization comprises UUAA for the UAV device 106, 201 and/or C2 authorization for the UAV device 106, 201.

Disclosed herein is a second method for receiving UAV authorization for a UAV 106 or 201, according to embodiments of the disclosure. The second method may be performed by a communication apparatus in a mobile communication network, such as a UAS0NF 147, a UAS0NF 213, and a UASNF #1 465, the UASNF #2 475 interacting with an AMF 143, an AMF 207, an AMF 455, an SMF 145, an SMF 209, an SMF 460, a UDM 149, a UDM 211, a USS/UTM system 157, and/or a USS/UTM system 205, described above.

The second method, in various embodiments, includes receiving a first request to authenticate an Unmanned Aerial Vehicle device 106, 201 for UAS services and determining whether the UAV device 106, 201 has a valid UAV authorization by checking a database storing information of UAVs that have been successfully authorized. The second method further includes determining an external identifier of the UAV device 106, 201 based on a second identifier and sending a second request to authenticate the UAV device 106, 201 with a USS/UTM system 157, 205 in which the second request includes the external identifier and the second identifier. The second method also includes receiving a UAV authorization result for the UAV device 106, 201 from the USS/UTM system 157, 205 and storing in the database an UAV context that indicates that the UAV device 106, 201 is authorized for UAS services. In certain embodiments, the UAV context includes the external identifier and/or the second identifier.

In further embodiments, the second method includes transmitting a first UAV payload container to the AMF 143, 207, 455 in which the first UAV payload container includes a third request for additional UAV information. The second method additionally includes receiving a second UAV payload container from the AMF 143, 207, 455 in which the second UAV payload container includes the requested additional UAV information and forwards the additional UAV information to the UAS-NF 147, 213. The UAV authorization for the UAV device 106, 201, in certain embodiments, is further based on the additional UAV information.

In some embodiments, the second identifier comprises a CAA-Level UAV identifier in which the database includes information that the CAA-Level UAV identifier has a valid authorization for the UAS services. Here, the processor further determines that the first request does not contain the CAA-Level UAV identifier and the processor sends a third request to retrieve the CAA-Level UAV identifier from the UAV device 106, 201.

In certain embodiments, retrieving the CAA-Level UAV identifier comprises transmitting a third request to an AMF 143, 207, 455 in response to determining that the UAV device 106, 201 is not authorized by the USS/UTM system 157, 205 and receiving the identifier for the UAV device 106, 201 and/or the flight information for the UAV device 106, 201 from the AMF 143, 207, 455. The third request, in some embodiments, requests an identifier for the UAV device 106, 201 and/or flight information for the UAV device 106, 201. In certain embodiments, the UAV authorization for the UAV device 106, 201 is based on the identifier for the UAV device and/or the flight information for the UAV device 106, 201.

The second identifier, in some embodiments, comprises a SUPI and determining the external identifier comprises using the SUPI to retrieve the external identifier from a UDM node 149, 211.

In certain embodiments, the first request is received from an SMF 145, 209, 460 and the processor further transmits the UAV authorization result to the SMF 145, 209, 460. In further embodiments, the request for UAV authorization comprises UUAA for the UAV device 106, 201 and/or C2 authorization for the UAV device 106, 201.

Disclosed herein is a third apparatus for receiving UAV authorization for a UAV 106 or 201, according to embodiments of the disclosure. The third apparatus may be implemented by a communication apparatus in a mobile communication network, such as an AMF 143, an AMF 207, and an AMF 455, described above. The first apparatus includes a transceiver for communicating with an SMF 145, an SMF 209, an SMF 460, a UDM 149, a UDM 211, a UAS-NF 147, a UAS-NF 213, a UASNF #1 465, the UASNF #2 475, a USS/UTM server 157, and/or a USS/UTM server 205, as described above. The third apparatus further includes a processor that interacts with and performs various operations with the SMF 145, the SMF 209, the SMF 460, the UDM 149, the UDM 211, the UAS-NF 147, the UAS-NF 213, the UASNF #1 465, the UASNF #2 475, the USS/UTM system 157, and/or the USS/UTM system 205.

In various embodiments, the processor is configured to receive a registration request to establish one or more user plane resources for UAS services for a UAV 106, 201 device and determine whether the UAV device 106, 201 has a valid prior UAV authorization by checking a locally stored UE context. The processor initiates a UAV authorization procedure in response to determining that no valid UAV authorization is stored for the UAV device 106, 201 and transmits a first request to an SMF 145, 209, 460 in which the first request including an indication to establish one or more user plane resources for UAS services for a UAV device 106, 201. The processor receives UAV authorization for the UAV device 106, 201 from the SMF 145, 209, 460 and the UAV authorization approved by a USS/UTM system 157, 205, and transmits the UAV authorization to the UAV device 106, 201.

The processor, in some embodiments further receives a second request from a UAS-NF 147, 213 to provide UAV information for the UAV device 106, 201 and transmits a first UAV payload container to the UAV device 106, 201 in which the first UAV payload container includes an information request for the UAV device 106, 201. The processor also receives a second UAV payload container from the UAV device 106, 201 in which the second UAV payload container includes information for the UAV device 106, 201 responsive to the information request and forwards the second payload container to the UAS-NF 147, 213. In further embodiments, the information request includes an identifier request for the UAV device 106, 201 and/or a flight information request for the UAV device 106, 201 and the information for the UAV device 106, 201 responsive to the information request comprises an identifier for the UAV device 106, 201 and/or flight information for the UAV device 106, 201.

In additional embodiments, the processor further receives a third UAV payload container from the UAS-NF 147, 213 in which the third UAV payload container includes a third request for additional authorization information for the UAV device 106, 201 and forwards the third UAV payload container to the UAV device 106, 201. The processor also receives a fourth UAV payload container from the UAV device 106, 201 in which the fourth UAV payload container includes the additional authorization information for the UAV device 106, 201 requested by the UAS-NF 147, 213 and forwards the fourth UAV payload container to the UAS-NF 147, 213.

Disclosed herein is a third method for receiving UAV authorization for a UAV 106 or 201, according to embodiments of the disclosure. The third method may be performed by a communication apparatus in a mobile communication network, such as an AMF 143, an AMF 207, and an AMF 455 interacting with an SMF 145, an SMF 209, an SMF 460, a UDM 149, a UDM 211, a UAS-NF 147, a UAS-NF 213, a UASNF #1 465, the UASNF #2 475, a USS/UTM server 157, and/or a USS/UTM server 205, as described above.

In various embodiments, the third method includes receiving a registration request to establish one or more user plane resources for UAS services for a UAV 106, 201 device and determining whether the UAV device 106, 201 has a valid prior UAV authorization by checking a locally stored UE context. The third method further includes initiating a UAV authorization procedure in response to determining that no valid UAV authorization is stored for the UAV device 106, 201 and transmitting a first request to an SMF 145, 209, 460 in which the first request including an indication to establish one or more user plane resources for UAS services for a UAV device 106, 201. The third method also includes receiving UAV authorization for the UAV device 106, 201 from the SMF 145, 209, 460 and the UAV authorization approved by a USS/UTM system 157, 205 and transmitting the UAV authorization to the UAV device 106, 201.

The third method, in some embodiments further includes receiving a second request from a UAS-NF 147, 213 to provide UAV information for the UAV device 106, 201 and transmitting a first UAV payload container to the UAV device 106, 201 in which the first UAV payload container includes an information request for the UAV device 106, 201. The third method also includes receiving a second UAV payload container from the UAV device 106, 201 in which the second UAV payload container includes information for the UAV device 106, 201 responsive to the information request and forwarding the second payload container to the UAS-NF 147, 213. In further embodiments, the information request includes an identifier request for the UAV device 106, 201 and/or a flight information request for the UAV device 106, 201 and the information for the UAV device 106, 201 responsive to the information request comprises an identifier for the UAV device 106, 201 and/or flight information for the UAV device 106, 201.

In additional embodiments, the third method further includes receiving a third UAV payload container from the UAS-NF 147, 213 in which the third UAV payload container includes a third request for additional authorization information for the UAV device 106, 201 and forwarding the third UAV payload container to the UAV device 106, 201. The third method also includes receiving a fourth UAV payload container from the UAV device 106, 201 in which the fourth UAV payload container includes the additional authorization information for the UAV device 106, 201 requested by the UAS-NF 147, 213 and forwarding the fourth UAV payload container to the UAS-NF 147, 213.

Embodiments may be practiced in other specific forms. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. A method of a network function in a mobile communication network, the method comprising:
receiving a first request from an Access and Mobility Management Function (“AMF”), the first request including an indication to establish user plane resources for Unmanned Aerial System (“UAS”) services for an Unmanned Aerial Vehicle (“UAV”) device;
retrieving subscription information from a Unified Data Management node (“UDM”), the subscription information indicating that UAV authorization is required by a UAS Service Subscriber (“USS”) and/or UAS Traffic Management (“UTM”) server; and
sending a second request to a UAS network function (“UAS-NF”) to initiate the UAV authorization.

2. The method of claim 1, wherein the UAV authorization comprises one or more of: a Command and Control (“C2”) authorization for the UAV device, and a UAV USS Authorization/Authentication (“UUAA”) for the UAV device, wherein the second request includes an indication of whether authorization is for C2 operation and/or for UUAA.

3. The method of claim 1, wherein the first request comprises one or more of: a UAV identifier and flight authorization information, the method further comprising receiving an authorization response that comprises one or more of a UAV authorization token and a flight authorization identifier.

4. The method of claim 3, wherein the second request to the UAS-NF includes an address of the USS and/or UTM server for authorization, the UAV identifier, and the flight authorization information provided by the UAV.

5. The method of claim 1, wherein the subscription information from the UDM comprises Session Management subscription data, wherein the Session management subscription data comprises network slice-level data, wherein the Session management subscription data contains, for each DNN, an indication of whether a request to establish user plane resources requires UAV authorization from the USS and/or UTM server.

6. The method of claim 1, further comprising:
determining whether valid UAV authorization information for the UAV device is stored in a local memory,
wherein retrieving the subscription information data from the UDM occurs in response to determining that no valid UAV authorization information for the UAV is stored in the local memory; and
storing, in local memory, a Session Management (“SM”) context that indicates that the UAV device is authorized for UAV operation in response to receiving an authorization response from the UAS-NF.

7. The method of claim 1, wherein the authorization response is contained within a UAS payload received from the USS and/or UTM server via the UAS-NF, wherein the UAS payload includes a UAV authorization result for the UAV for one or more network slices.

8. An apparatus in a mobile communication network, the apparatus comprising:
a transceiver; and
a processor that:
receives a first request to authenticate an Unmanned Aerial Vehicle (“UAV”) device for Unmanned Aerial System (“UAS”) services;
determines whether the UAV device has a valid UAV authorization by checking a database, said database storing information of UAVs which have been successfully authorized;
determines an external identifier of the UAV device based on a second identifier;
sends a second request to authenticate the UAV device with an UAS Traffic Management (“UTM”) system, the second request comprising the external identifier and the second identifier;
receives a UAV authorization result for the UAV device from the UTM system; and
stores in the database an UAV context that indicates that the UAV device is authorized for Unmanned Aerial System (“UAS”) services, said UAV context comprising one or more of the external identifier and the second identifier.

9. The apparatus of claim 8, wherein the second identifier comprises a CAA-Level UAV identifier, wherein the database includes information that the CAA-Level UAV identifier has a valid authorization for the UAS services.

10. The apparatus of claim 9, wherein the processor further determines that the first request does not contain the CAA-Level UAV identifier, wherein the processor sends a third request to retrieve the CAA-Level UAV identifier from the UAV device.

11. The apparatus of claim 8, wherein the second identifier comprises a subscription permanent identifier (“SUPI”), wherein determining the external identifier comprises using the SUPI to retrieve the external identifier from a Unified Data Management node (“UDM”).

12. The apparatus of claim 8, wherein the first request is received from a Session Management Function (“SMF”), wherein the processor further transmits the UAV authorization result to the SMF.

13. The apparatus of claim 12, wherein the first request for UAV authorization comprises one of UAV Authorization/Authentication (UUAA) for the UAV device and Command and Control (C2) authorization for the UAV device.

14. An apparatus in a mobile communication network, the apparatus comprising:
a transceiver; and
a processor that:
receives a registration request to establish one or more user plane resources for Unmanned Aerial System (“UAS”) services for an Unmanned Aerial Vehicle (“UAV”) device;
determines whether the UAV device has a valid prior UAV authorization by checking a locally stored User Equipment (“UE”) context;
initiates a UAV authorization procedure in response to determining that no valid UAV authorization is stored for the UAV device;
transmits a first request to a Session Management Function (“SMF”), the first request including an indication to establish one or more user plane resources for Unmanned Aerial System (“UAS”) services for an Unmanned Aerial Vehicle (“UAV”) device;
receives UAV authorization for the UAV device from the SMF, the UAV authorization approved by a UAS Traffic Management (“UTM”) system; and
transmits the UAV authorization to the UAV device.

15. The apparatus of claim 14, wherein the processor further:
receives a second request from a UAS network function (“UAS-NF”) to provide UAV information for the UAV device;
transmits a first UAV payload container to the UAV device, the first UAV payload container including an information request for the UAV device;
receives a second UAV payload container from the UAV device, the second UAV payload container including information for the UAV device responsive to the information request; and
forwards the second payload container to the UAS-NF.
